(19) United States
(12) Patent Application Publication
(10) Pub. No.: US 2016/0358065 A1
(43) Pub. Date: Dec. 8, 2016

(54) Personally Impactful Changes To Events of Users

(71) Applicant: Microsoft Technology Licensing, LLC, Redmond, WA (US)

(72) Inventors: Nick Gedge, Redmond, WA (US); David Magar, Sammamish, WA (US); Michael Wascher, Redmond, WA (US); Richard Zhao, Kenmore, WA (US); Suryakant Choudhary, Redmond, WA (US)

(21) Appl. No.: 14/866,292

(22) Filed: Sep. 25, 2015

Related U.S. Application Data
(60) Provisional application No. 62/171,635, filed on Jun. 5, 2015.

(51) Int. Cl. G06N 3/00; G06N 99/00; G06N 5/04

(52) U.S. Cl. CPC G06N 3/006; G06N 5/047; G06N 99/005

(57) ABSTRACT

In some implementations, sensors provide sensor data reflecting user activity detected by the sensors. An event analyzer generates an impact score for a change to an event associated with a user based on routine-related aspects generated from one or more user routine models associated with the user. The one or more user routine models are trained based at least in part on interaction data comprised of the sensor data. The impact score may be generated by analyzing the event attributes with respect to the routine-related aspects. The impact score is generated based on determining a difference in a level of deviation caused by the change, between one or more event attributes and routine-related aspects and based on comparing a time of the event to a reference time. The impact score can be used to determine which changes to events are important to the user.

### CROSS-REFERENCE TO RELATED APPLICATIONS

This application claims the benefit of U.S. Provisional Application No. 62/171,635, titled “Personally Impactful Changes To Events Of Users,” filed Jun. 5, 2015, which is hereby expressly incorporated by reference in its entirety.

### BACKGROUND

Automated calendaring software can employ e-mail or other mechanisms to invite one or more users to events, or meetings. More traditional examples include Microsoft® Outlook® and Lotus Notes®, however more recent examples can be found as cloud based services and/or as services integrated into mobile phones. Examples of events, or meetings, include traditional face-to-face meetings, teleconferences, videoconferences, and online group chats. In some cases, to schedule a meeting, an organizer may use a service to send an invitation to one or more invitees. The invitation typically indicates one or more event attributes that may be set by the organizer, such as a date and time for the meeting, a location for the meeting, whether the meeting is recurring or when the meeting will recur, and comments. The service typically tracks responses from the invitees, such as whether invitees accept, reject, tentatively accept, or propose a new time. Based on the responses, the service can update or set one or more event attributes, such as by maintaining a list of attendees (e.g., planned attendees) for the event. Further, the service may automatically add the meeting as a calendar event, or entry, in a personal calendar of each of the users. Users can plan and/or receive invitations for many different events using one or more scheduling services and may have many entries in their calendars.

Often one or more event attributes of events may be modified (attributes may be added, changed, or removed) by one or more users after being initially set by the original organizer or another user. Certain changes may pose little threat to disrupting the life of some of the planned attendees of the event. However, for other attendees, the changes may be more significant and they would benefit from taking some time before the event to adjust their plans or otherwise prepare for the event based on the changes. As one example, when a scheduled location of an event changes, certain attendees may need to adjust their travel arrangements in order to attend the event. However, these significant changes may go unnoticed by some users, leaving them unable to properly prepare, or may be noticed when there is no longer sufficient time to adjust to the changes. This can result in users constantly checking for updates to their events to stay informed, which can drain battery life of user devices, as well as consume server resources and bandwidth. Furthermore, important changes may be buried with unimportant changes, such that the user consumes large amounts of these resources due to the extended time required pick out the important changes.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Implementations of the present disclosure are directed towards systems and methods for detecting changes to planned events of users that are personally impactful to the users. A change to an event can correspond to a change to one or more event attributes with respect to the event including adding, removing, or modifying an event attribute. In various implementations, the impact of a change to an event to a user is quantified based on a difference in the unusualness of the event to the user caused by the change, combined with the urgency that the user be notified of the change. The impact of the change to the event can be used to determine whether to notify the user of the change, and/or when to notify the user of the change. In doing so, sufficiently impactful changes to events can be brought to the attention of the user so that the user is can be automatically notified of these changes in an appropriate manner. Thus, the user can have time to properly prepare for the changes to mitigate their often disruptive nature without having to manually search for and monitor updates to events.

In certain respects, the unusualness of an event can be assessed with respect to various habitual aspects of the user's life so as to indicate to what extent an event breaks from or conforms to what is routine to the user. As such, the difference in the unusualness of an event caused by a change to the event can indicate a change in the extent that the event breaks from or conforms to what is routine to the user.

In some cases, a variety of factors may be incorporated into the overall unusualness of an event. Each factor may represent a respective aspect of unusualness with respect to the event and combine to quantify the overall unusualness of the event. For example, each factor can correspond to a respective level of deviation between a set of event attributes (one or more) of the event and a set of routine-related aspects (one or more) of a user. Exemplary factors include commute-based factors, sleep-based factors, location or venue visitation-based factors, and affinity-based factors.

In various implementations, the impact of a change to an event can be assessed with respect to one or more of these factors and/or with respect to the overall unusualness of the event. Thus, the system can potentially access the impact of change with respect to individual event attributes of events and/or combinations thereof. As such, in some cases, the system may determine which aspects of changes to events are sufficiently impactful to be brought to the attention of the user.

### BRIEF DESCRIPTION OF THE DRAWINGS

Aspects of the invention are described in detail below with reference to the attached drawing figures, wherein:

FIG. 1 is a block diagram of an example operating environment suitable for implementing aspects of the invention;

FIG. 2 is a diagram depicting an example computing architecture suitable for implementing aspects of the invention;

FIG. 3 is a diagram depicting an example computing architecture suitable for implementing aspects of the invention;

FIG. 4A depicts exemplary service content displayed to a user in accordance with aspects of the invention;

FIG. 4B depicts exemplary service content displayed to a user in accordance with aspects of the invention;

FIG. 5 depicts a flow diagram of a method, in accordance with an implementation of the invention;

FIG. 6 depicts a flow diagram of a method, in accordance with an implementation of the invention;

FIG. 7 depicts a flow diagram of a method, in accordance with an implementation of the invention; and

FIG. 8 is a block diagram of an exemplary computing environment suitable for use in implementing an implementation of the invention.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed towards systems, methods, and computer storage media for, among other things, inferring aspects related to a specific user's behavior patterns, or routines, using a routine model for the user based, at least in part, on sensor data reflecting user activity as detected by one or more sensors (“interaction data”). As used herein, “user routine models” are probabilistic, machine learning constructs that infer or predict routine-related aspects associated with a specific user's behavior patterns (“routine-related aspects”) by evaluating features, attributes, or variables (“routine-related features”) according to rules, frameworks, or machine learning algorithms (“routine-related logic”) that define logical relationships amongst routine-related features or between routine-related features and routine-related inferences. In some implementations, routine-related logic further defines procedures, processes, or operations used to determine the various metrics, scores, or values associated with routine-related inferences, such as confidence scores, variance metrics, central tendency values, probability distribution functions, and the like.

“Routine-related inferences,” as used herein, describe inferences, estimations, or approximations that provide additional insight into the specific user's behavior patterns. As such, routine-related inferences enable identification of one or more routine-related aspects that more closely reflect what the specific user's behavior will likely be at a future time. Routine-related inferences are determined by evaluating (or analyzing) one or more routine-related features derived from data associated with currently-sensed interaction data with user routine models trained using data associated with previously-sensed interaction data. In some implementations, routine-related inferences are used to generate or update routine-related profiles associated with a specific user in order to provide time-sensitive recommendations personalized to the specific user's behavior pattern.

The term “service” is used broadly herein to refer to nearly any application or automation technology which may be implemented as one or more computer applications, services, or routines, such as an app running on a mobile device or the cloud, as further described herein. Similarly, the term “recommendation” is used broadly herein to refer to any recommendations, features, actions, operations, notifications, functions, and/or other utilities provided by services. The term “logic” encompasses any physical and tangible functionality for performing a task. For instance, each operation illustrated in the flowcharts may correspond to a logic component for performing that operation. An operation can be performed using, for instance, software running on computer equipment, hardware (e.g., chip-implemented logic functionality), etc., and/or any combination thereof. When implemented by computing equipment a logic component represents an electrical component that is a physical part of the computing system, however implemented.

Implementations of the present disclosure are directed towards systems and methods for detecting changes to events of users that are personally impactful to the users. A change to an event can correspond to a change to one or more event attributes of the event including adding, removing, or modifying an event attribute. In various implementations, the impact of a change to an event to a user is quantified based on a difference in the unusualness of the event to the user caused by the change, combined with the urgency that the user be notified of the change. Unusualness can be assessed with respect to what is ordinary and expected in the users' everyday life. Thus, when one or more aspects of an event become more or less unusual, the user's expectations for the event may change. In various aspects of the present disclosure, a notion of these changed expectations is coupled with a notion of how urgent changes to events are to the user. In this way, the most important changes to events can be determined and surfaced to the user and/or a suitable manner or time of surfacing the changes to the user can be determined.

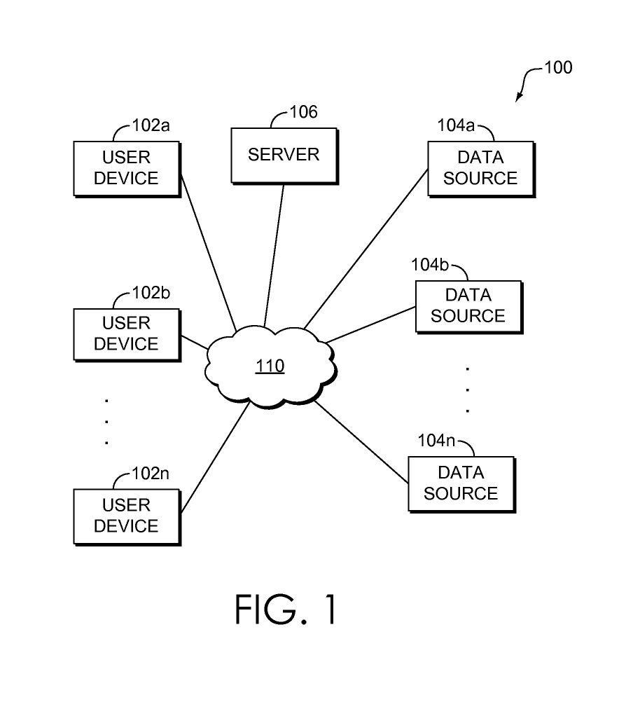

Turning now to FIG. 1, a block diagram is provided showing an example operating environment 100 in which some implementations of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

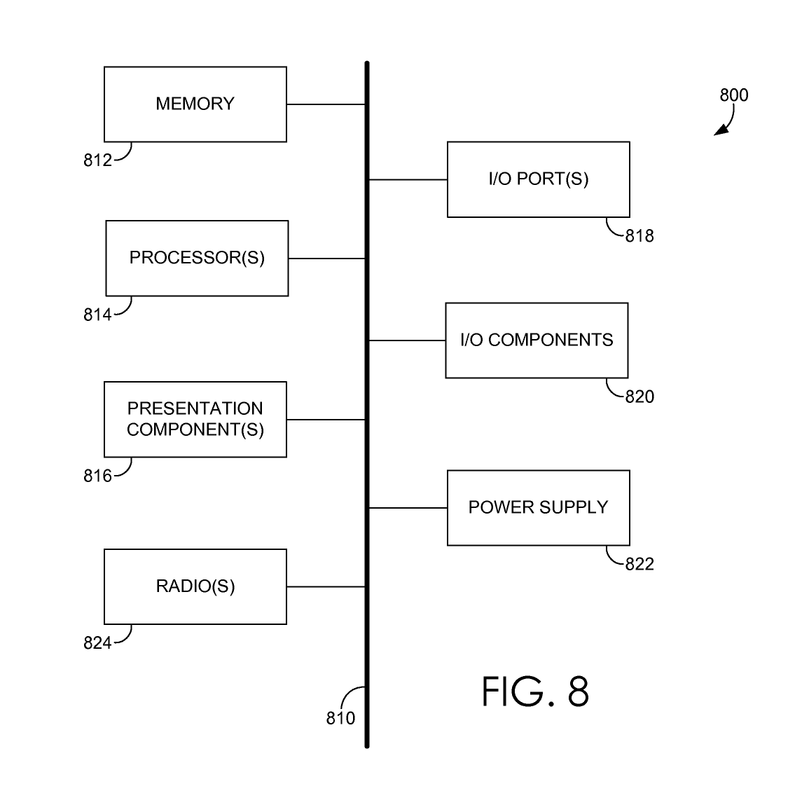

Among other components not shown, example operating environment 100 includes a number of user devices, such as user devices 102a and 102b through 102n; a number of data sources, such as data sources 104a and 104b through 104n; server 106; and network 110. It should be understood that operating environment 100 shown in FIG. 1 is an example of one suitable operating environment. Each of the components shown in FIG. 1 may be implemented via any type of computing device, such as computing device 800, described in connection to FIG. 8, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of being operated by a user. For example, in one implementation, user devices 102a through 102n may be the type of computing device described in relation to FIG. 8 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device.

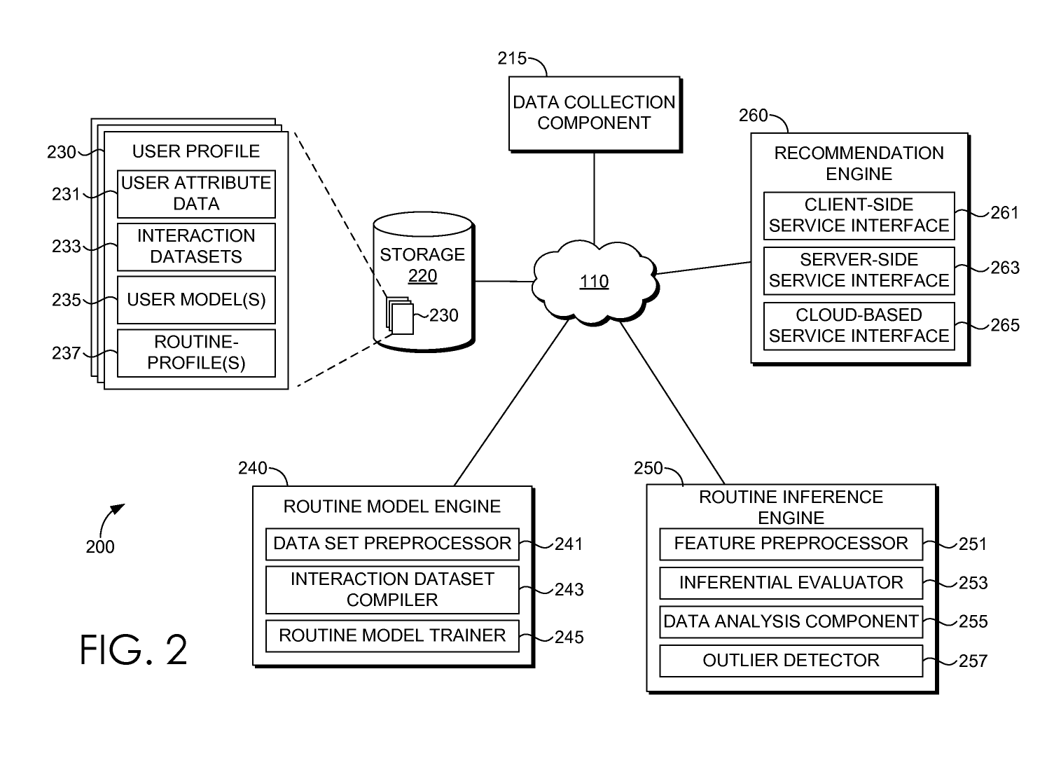

Data sources 104a and 104b through 104n may comprise data sources and/or data systems, which are configured to make data available to any of the various constituents of operating environment 100, or system 200 described in connection to FIG. 2. (For example, in one implementation, one or more data sources 104a through 104n provide (or make available for accessing) user data to data collection component 215 of FIG. 2.) Data sources 104a and 104b through 104n may be discrete from user devices 102a and 102b through 102n and server 106 or may be incorporated and/or integrated into at least one of those components. In one implementation, one or more of data sources 104a though 104n comprises one or more sensors, which may be integrated into or associated with one or more of the user device(s) 102a, 102b, or 102n or server 106. Examples of sensed user data made available by data sources 104a though 104n are described further in connection to data collection component 215 of FIG. 2.

Operating environment 100 can be utilized in conjunction with the components of the exemplary computing system architecture depicted in FIG. 2 that is suitable for implementing embodiments of the invention and is generally designated as system 200. System 200 represents only one exemplary computing system architecture suitable for implementing aspects of the invention. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location. Among other components not shown, system 200 is generally comprised of components for inferring routine-related aspects for a specific user based on interaction data. System 200 includes such components as data collection component 215, storage 220, routine model engine 240, routine inference engine 250, and recommendation engine 260, all of which are communicatively coupled via network 110.

In some implementations, the functions performed by components of system 200 are associated with one or more personal assistant applications, services, or routines. In particular, such applications, services, or routines may operate on one or more user devices (such as user device 102a), servers (such as server 106), may be distributed across one or more user devices and servers, or be implemented in the cloud. Moreover, in some implementations these components of system 200 may be distributed across a network, including one or more servers (such as server 106) and client devices (such as user device 102a), in the cloud, or may reside on a user device such as user device 102a. As with operating environment 100, some of the components described herein may be embodied as a set of compiled computer instructions, computer functions, program modules, computer software services, or an arrangement of processes carried out on one or more computer systems, such as computing device 800 described in connection to FIG. 8.

For example, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the implementations of the invention described herein can be performed, at least in part, by one or more hardware logic components. Exemplary types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some implementations functionality of these components can be shared or distributed across other components.

Data collection component 215 is generally responsible for acquiring, accessing, or receiving (and in some cases also identifying) interaction data from one or more data sources, such as data sources 104a and 104b through 104n of FIG. 1. For example, interaction data may be received from a plurality of user devices (such as user devices 102a and 102b through 102n of FIG. 1) associated with a user or in some instances, associated with multiple users. In this way, user activity of a particular user from multiple user devices used by the user (e.g. the user's mobile phone, laptop, tablet, etc.), may be received as interaction data. Interaction data may be received, acquired, or accessed, and optionally accumulated, reformatted and/or combined, by data collection component 215 and stored in one or more data stores such as storage 220. For example, interaction data may be stored in or associated with a user profile 230, as described herein. The one or more data stores may thus be available to routine model engine 240, routine inference engine 250, and recommendation engine 260. In some implementations, data collection component 215 is configured to accumulate interaction data reflecting user activity detected by one or more sensors for an individual user (“individual-sourced interaction data”). In some implementations, data collection component 215 is configured to accumulate interaction data associated with user-source interactions for a plurality of users (“crowd-sourced interaction data”). In some implementations, any personally identifying data (i.e., interaction data that specifically identifies particular users) is either not uploaded from the one or more data sources with interaction data, is not permanently stored, and/or is not made available to routine model engine 240, routine inference engine 250, and/or recommendation engine 260.

Interaction data may be received from a variety of sources where the data may be available in a variety of formats. For example, in some implementations, user data accumulated by data collection component 215 is received via one or more sensors associated with user devices (such as user device 102a and/or other devices associated with the user), servers (such as server 106), and/or other computing devices. As used herein, a sensor may include a function, routine, component, or combination thereof for sensing, detecting, or otherwise obtaining information such as user data from data sources (e.g., data source 104a of FIG. 1), and may be embodied as hardware, software, or both.

By way of example and not limitation, user data may include data that is sensed or determined from one or more sensors (referred to herein as “sensor data”), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user-data associated with communication events; etc.) including user activity that occurs over more than one user device, user history, session logs, application data, contacts data, calendar and schedule data, notification data, social-network data, news (including popular or trending items on search engines or social networks), online gaming data, ecommerce activity (including data from online accounts such as a Microsoft® account, Amazon.com®, eBay®, PayPal®, or Xbox Live®), user-account(s) data (which may include data from user preferences or settings associated with a personal assistant application or service), home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, Cellular network, or IP address data), and nearly any other source of data that may be sensed or determined as described herein.

In some respects, user data may be provided in user signals. A user signal can be a feed of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some implementations, data collection component 215 receives or accesses data continuously, periodically, or as needed.

In general, storage 220 is configured to store computer instructions (e.g., software program instructions, routines, or services), and/or models used in implementations of the invention described herein. In some implementations, storage 220 also stores information or data received via the various components of system 200 and provide the various components of system 200 with access to that information or data. For example, storage 220 may store such information or data as interaction data, descriptive information associated with any of the user data described with respect to data collection component 215, interaction data, inferential data, interaction datasets, crowd-sourced datasets, individual-sourced datasets, user routine models, routine-related inferences, routine-related profiles, and one or more user profiles (e.g. user profiles 230). In an implementation, storage 220 comprises a data store (or computer data memory). Further, although depicted as a single data store component, storage 220 may be embodied as one or more data stores or may be in the cloud.

Exemplary user profile 230 includes information associated with a specific user, or in some implementations, a group or category of users. As shown in FIG. 2, user profiles 230 include such information as: user attribute data 231, interaction datasets 233, user routine models 235, and routine-related profiles 237. The information stored in user profiles 230 may be available to the other components of exemplary system 200.

User attribute data 231 comprises any characteristic, trait, or attribute associated with a specific user. In some implementations, user attribute data 231 includes information relating to demographic data, location data, occupational data, educational data, and the like. For example, demographic data includes such information as age, gender, nationality, religious affiliations, ethnicities, and the like. As another example, location data includes such information for the specific user as: current physical location, work location, home location, projected future location(s), and the like. In some implementations, similar location data may be available for one or more user devices or one or more individuals associated with the specific user (e.g. friends, family, etc.). User attribute data 231 may be acquired from users in a variety of ways. In some implementations, user attribute data 231 is submitted by users to system 200 (e.g., explicitly) via any of the input devices described below with respect to computing device 800 of FIG. 8. In some implementations, user attribute data 231 is compiled from user data submitted by users as part of registering for user profiles with applications; social media profile building; census registration; and the like. In some implementations, user attribute data 231 is acquired from one or more reports associated with users, such as credit reports; background reports; employment reports; and the like.

Interaction dataset 233 broadly pertains to any dataset populated using any data associated with previously-sensed interaction data that is used to train, test, and/or validate user routine models 235. A user routine model 235 may be a machine-learned, probabilistic inference model configured to determine routine-related inferences by evaluating data associated with currently-sensed interaction data, in some implementations. Routine-related profile 237 may include information regarding one or more routine-related aspects for a specific user. Routine-related profile 237 may be initialized and/or updated using routine-related inferences determined by evaluating currently-sensed interaction data using User routine model 235. By way of example, for a sleep-related routine, routine-related aspects, could include one or more of the following aspects of a specific user's sleep pattern: bedtime, wakening time, bedtime range, wakening time range, sleep duration, and the like. Routine-related aspects of routine-related profile 237 may be represented according to any known probabilistic machine learning model output. For example, routine-related aspects may be represented as a statistical distribution describing a particular in terms of a central tendency metric (e.g. a mean, a median, or a mode) and a variance metric (e.g. a range, a standard deviation, or a variance). Further details regarding interaction datasets 233, user routine models 235, and routine-related profiles 237 are described below with respect to routine model engine 240.

Routine model engine 240 is generally adapted to populate interaction datasets 233 in cooperation with storage 220 and train user routine models 235 using those interaction datasets 233. User routine models 235 trained by routine model engine 240 enable routine inference engine 250 to infer (or predict) routine-related aspects for a specific user. As shown in exemplary system 200, routine model engine 240 includes dataset preprocessor 241, interaction dataset compiler 243, and routine model trainer 245.

Dataset preprocessor 241 may be configured to create user-attribute filters using user attribute data 231, in implementations where crowd-sourced datasets are used to populate interaction datasets 233. In these implementations, user routine models 235 may, in a sense, be pre-tailored for a specific user through selecting previously-sensed interaction data that is more relevant to the specific user for use in training user routine models. Dataset preprocessor 241 enables such pre-tailoring of user routine models 235 by applying at least one user attribute filter to crowd-sourced datasets prior to populating interaction datasets 233 with their associated previously-sensed interaction data. In some implementations, user attribute filters are based on data acquired from user attribute data 231 associated with user profiles 230. In some implementations, user attribute filters may be based on data acquired from users via any of the input devices described below with respect to computing device 800 of FIG. 8.

For example, a user-location filter may be applied to crowd-sourced datasets to exclude previously-sensed interaction data associated with users outside of a pre-determined distance range from a specific user. As another example, a user-demographic filter may be applied to crowd-sourced datasets to only include previously-sensed interaction data associated with users having at least one demographic characteristic in common with a specific user (e.g. age, income, cultural identity, gender, etc.). In another example, a user-occupation filter is applied to crowd-sourced data sets to only include previously-sensed interaction data associated with users having at least one occupational characteristic in common with a specific user (e.g. job title, industry, level of experience, etc.).

Interaction dataset compiler 243 is configured to populate, compile, or build interaction datasets 233 with previously-sensed interaction data received from data collection component 215, storage 220, and/or routine inference engine 250. In some implementations, interaction dataset 233 is populated with individual-sourced data reflecting a specific user's activity as detected by one or more sensors. In some implementations, interaction dataset 233 is populated with crowd-sourced interaction data reflecting the activity of multiple users as detected by one or more sensors. In some implementations, interaction dataset 233 is populated with descriptive data associated with previously-sensed interaction data, such as time/date stamps, metadata tags, geographical location data, etc. In some implementations, interaction dataset is populated with interpretive data as discussed in more detail below with respect to inferential evaluator 253.

Implementations of routine model trainer 245 may be configured to train user routine models (e.g. User routine model 235) through analyzing interaction datasets 233 to identify routine-related features, routine-related logic, and in some implementations routine-related weights. As discussed above, in some implementations, User routine model 235 comprises a machine-learned, probabilistic inference model configured to determine routine-related inferences by evaluating data associated with currently-sensed interaction data. As such, User routine model 235 may be trained by any machine learning technique known by those skilled in the art.

Routine-related features may be identified by routine model trainer 245 based on any combination of user data described in connection to data collection component 215, descriptive information associated with such user data, and interpretive data provided by inferential evaluator 253. In some implementations, routine-related features are identified by routine model trainer 245 recognizing patterns between data within interaction dataset 233 and a specific user's routine. For example, routine model trainer 245 may use a pre-determined statistical threshold, such as a correlation threshold (either positive or negative), to recognize such patterns. Pre-determined statistical thresholds may reflect relationships among identified routine-related features or between routine-related features and various aspects of the specific user's routine.

In some implementations, routine-related features utilize user signals providing a feed of interaction data from data sources (e.g. a user device) associated with a user. In these implementations, feeds of interaction data may be provided at any level of granularity including: continuously, periodically (e.g. every minute, 5 minutes, hour, 2 hours, etc.), or upon the user signal transitioning logic states (e.g. off to on, high to low, etc.). User signals providing a feed of interaction data may be received from sensors associated with applications or devices on a client-side, on a server-side, in the cloud, or any combination thereof.

Routine model trainer 245 is further configured to determine routine-related logic for user routine models that maps data associated with interaction data to routine-related features and defines logical relationships amongst routine-related features and/or between routine-related features and routine-related inferences. In some implementations, routine-related logic further define procedures, processes, or operations used to determine the various metrics, scores, or values associated with routine-related inferences, such as confidence scores, variance metrics, central tendency values, probability distribution functions, and the like.

In some implementations, confidence scores are employed to quantify a degree of confidence in how accurately one or more routine-related aspects associated with a routine-related profile will reflect the user's routine. In these implementations, confidence scores may be associated with the routine-related profile overall, particular routine-related aspects of the routine-related profile, and/or one or more metrics (e.g. variance metric, central tendency metric, etc.) associated with particular routine-related aspects of the routine-related profile. Stated differently, a confidence score is an associated probability or confidence that indicates a likelihood of a predicted routine-related aspect coinciding with a user's actual routine. In some implementations, services use the confidence score in various ways, such as for a threshold in providing time-sensitive recommendations to a user.

Routine model trainer 245 may be further configured to assign at least one routine-related weight for the routine-related features in implementations where routine-related weights are used. Routine-related weights may be determined by analyzing interaction datasets 233 used to train user routine models 235. Routine-related weights reflect a corresponding routine-related feature's relative statistical significance in determining (predicting the likelihood of) a routine-related inference. Such routine-related weights may be assigned by routine model trainer 245 to one or more routine-related features associated with user routine models.

Although FIG. 2 depicts routine model engine 240 as a separate component, those skilled in the art will recognize that routine model engine 240, or any sub-component thereof, may be integrated with another component, such as an interaction data collection component, an analysis tool, a user device, a web server, or the like. In some implementations, routine model engine 240 is implemented as part of routine inference engine 250 or other components similarly designed to generate routine-related profiles. In some implementations, routine model engine 240 is implemented as part of a web server, a hybrid hardware/software component, or as a software module running on a conventional personal computer that is being used to infer routine-related aspects of user sleep patterns using interaction data.

Routine inference engine 250, in general, is configured to infer routine-related aspects by analyzing currently-sensed interaction data with user routine models trained using previously-sensed interaction data. As shown in exemplary system 200, routine inference engine 250 includes feature preprocessor 251, inferential evaluator 253, data analysis component 255, and outlier detector 257.

Feature preprocessor 251 is configured to map data associated with interaction data to generate routine-related features for analysis by data analysis component 255, as identified by routine model trainer 245. Routine-related features generated by feature preprocessor 251 may include any of the data associated with interaction data discussed herein. In some implementations, feature preprocessor 251 is further configured to convert data associated with interaction data into appropriate formats for mapping to routine-related features, as specified by routine model trainer 245. For example, data associated with interaction data may be received as analog data or digital data provided as any number of data types including: matrices; vectors; and scalars. In this example, feature preprocessor 251 converts such data into an appropriate format for corresponding routine-related features to be usable by data analysis component 255.

In some implementations, feature preprocessor 251 may map data associated with currently-sensed interaction data from a single data source to a single routine-related feature. For example, feature preprocessor 251 may map currently-sensed interaction data from an alarm clock application running on a specific user's smart phone to a single routine-related feature. In this example, routine model trainer 245 determined the specific user regularly deactivates the alarm clock application on the smart phone shortly after awakening.

In some implementations, feature preprocessor 251 may map data associated with currently-sensed interaction data from a plurality of data sources to a single routine-related feature. For example, feature preprocessor 251 may map currently-sensed interaction data from a news website hosted by a remote server with which a specific user is interacting and a user device the specific user is using to interact with the news website to a single-related feature. In this example, the descriptive data may be in the form of a device identifier associated with interaction data received from a user device. Routine model trainer 245 determined, in this example, that the specific user reads news articles on the news website on a tablet computing device prior to bedtime. Whereas, interaction data collected from the same news website would not be useful to infer the specific user's bedtime if the specific user interacts with the news website on a smart phone while getting ready for work in the morning.

Inferential evaluator 253 may be configured to extract interpretive data from sensed interaction data and provide the extracted interpretive data to storage 220 for use by other components of system 200. Interpretive data, in general, corresponds to any information providing context to any interaction data utilized by system 200 by describing circumstances surrounding users, devices, and/or applications when interaction data is acquired. Stated differently, interpretive data provides background information for sensed interaction data that enables system 200 to identify more patterns within interaction datasets 233 than would otherwise possible if system 200 was unaware of the surrounding circumstances.

Examples of interpretive data include: tasks being performed at the time, such as military reserve training, trying to lose weight resulting in users waking up earlier to jog; information regarding temporal significance such as birthdays, holidays, anniversaries, seasons of the year, special events, vacations, associations between recent events; information regarding geographical significance, such as work place/home locations, changes in location (e.g. moving from one city to another city or one time zone to another time zone), vacation destinations; or any other information that provides system with a higher level of understanding about circumstances surrounding sensed interaction data.

Data analysis component 255 is generally configured to implement routine-related logic provided by routine model engine 240 in user routine models on routine-related features comprised of data associated with interaction data from feature preprocessor 251. By implementing routine-related logic on routine-related features, data analysis component 255 is able to determine routine-related inferences and the various metrics, scores, or statistical information associated with routine-related inferences, such as confidence scores, variance metrics, central tendency values, probability distribution functions, and the like. In cooperation with storage 220, data analysis component 255 may be further configured to update (or initialize) routine-related profiles associated with the specific user using routine-related inferences and the various metrics, scores, or statistical information associated with routine-related inferences determined from currently-sensed interaction data.

Outlier detector 257 may be configured to identify routine-related inferences deviating from previously determined routine-related inferences enough to constitute a statistical outlier (“outlier inferences”) using a pre-determined cutoff. For example, the pre-determined cutoff may be established according to known statistical anomaly detection methods, such as: Fuzzy Logic based outlier detection; Cluster Analysis based outlier detection; Density-based techniques, or any other known statistical anomaly detection metric. In some implementations, outlier detector 257 compares routine-related inferences with previously determined routine-related inferences associated with particular routine-related profiles using a pre-determined cutoff.

In some implementations, data associated with routine-related inferences are identified as statistical outliers by outlier detector 257 and are stored in interaction datasets referred to herein as “outlier datasets.” Such data, for example, may include the determined routine-related inference, any routine-related features used to determine that routine-related inference, or any currently-sensed interaction data acquired within a specified time of determining that routine-related inference. In some implementations, outlier datasets are used to train user routine models according to any of the implementations disclosed herein. In these implementations, outlier datasets may be used instead of and to replace a portion of and/or be merged with interaction datasets in training user routine models that are referred to herein as “alternative user routine models.” In some implementations, routine-related inferences determined using alternative user routine models are used to generate routine related profiles (referred to herein as “alternative routine-related profiles”). In these implementations, alternative routine-related profiles may be identified using alternative profile labels based on some commonality within datasets used to train their respective alternative user routine model, as determined by routine model engine 240.

For example, if routine model engine 240 determines that an outlier dataset used to train an alternative user routine model is comprised of interaction data associated with a particular geographic location (e.g. Israel, Europe, a vacation home in Mexico, etc.). In this example, an alternative routine-related profile generated using routine-related inferences determined using this alternative user routine model may be identified using an alternative profile label designating the particular geographic location. Accordingly, the alternative routine-related profile of this example may comprise routine-related aspects for the specific user that are specific to that particular geographic location. For example, the specific user may wake up later when vacationing in Mexico compared to when they are home working.

As another example, a routine model engine 240 determines that an outlier dataset used to train an alternative user routine model is comprised of interaction data associated with a particular period of time (e.g. weekdays/weekends, summer/winter, specific weekends every month, etc.). In this example, an alternative routine-related profile generated using routine-related inferences determined using this alternative user routine model may be identified using an alternative profile label designating the particular period of time. Accordingly, the alternative routine-related profile of this example may comprise routine-related aspects for the specific user that are specific to that particular period of time. For example, the specific user may be in a military reserve unit, which results in the specific user waking up earlier on specific weekends of the month they are training with the military reserve unit versus when they are at home relaxing on the weekend.

Recommendation Engine 260 is configured to receive requests for routine-related aspects for a specific user, identify the requested routine-related aspects using routine-related profiles associated with the specific user, and provide the identified routine-related aspects to an application, service, or device submitting the request. In some implementations, recommendation engine 260 may be implemented as an application programming interface (“API”). As shown in FIG. 2, recommendation engine 260 is comprised of client-side service interface 261, server-side service interface 263, and cloud-based service interface 265.

Client-side service interface 261 is configured to receive requests from client-side recommendation applications or services that directly provide time-sensitive recommendations to a specific user. As an example, received requests could originate from an application running on the specific user's smart phone, such as a personal assistant application, or a communication application. In another example, a request could originate from a controller communicatively coupled to an actuator associated with any client-side device, machine, or appliance having automation capabilities used by the specific user.

Server-side service interface 263 is configured to receive requests from server-side applications or services that may be hosted on 3^{rd} party devices that provide recommendations to users. For example, the received request could originate from a server hosting a website offering commercial or informational services related to social media, traffic, weather, news, and the like. In some implementations, requests could be received from a recommendation engine associated with a routine inference engine associated with another user (e.g., the specific user's family members, friends, etc.). Similarly, cloud-based service interface 265 is configured to receive requests from any cloud-based applications or services.

A routine-related prediction of a routine-related aspect for a specific user may optionally be determined using currently-sensed interaction data and a user routine model trained using previously-sensed interaction data. An interaction dataset may be populated using previously-sensed interaction data. Previously-sensed interaction data can be received from an interaction data collection component (e.g., data collection component 215 of FIG. 2) prior to being accumulated in stored datasets. In some cases, previously-sensed interaction data is retrieved from stored datasets that include any of the interaction data described with respect to data collection component 215. For example, stored datasets may include accumulated previously-sensed interaction data associated with a specific user from an individual dataset. In another example, stored datasets may include accumulated previously-sensed interaction data associated with a plurality of users from a crowd-sourced dataset. In another example, stored datasets may include accumulated previously-sensed interaction data from an individual dataset, a crowd-sourced dataset, or a combination thereof.

In implementations using crowd-sourced datasets, pre-processing may be performed on previously-sensed interaction data retrieved from crowd-sourced datasets prior to populating interaction datasets. Such pre-processing may include noise filtering, removal of outlier data, and/or treatment of missing data. In implementations with crowd-soured datasets, pre-processing may include filtering previously-sensed interaction data from crowd-soured datasets using one or more filters based on user attributes (e.g., user attribute data 231 of FIG. 2). When used, the one or more filters segregate previously-sensed interaction data received from users with the user attributes from previously-sensed interaction data received from users without the user attributes. Consequently, filtered previously-sensed interaction data may be either included or excluded from the interaction dataset to provide previously-sensed interaction data that is generally tailored for training, testing, and/or validating user routine models.

The user routine model may be trained, tested, and/or validated using populated interaction datasets. As discussed above, user routine models are trained using any known machine learning technique by identifying one or more routine-related features in the interaction dataset. In some implementations, routine-related profiles for the specific user are generated by populating the routine-related profiles with initial values determined using previously-sensed interaction data in populated interaction datasets. In these implementations, confidence scores associated with such routine-related profiles are assigned a minimal value (e.g. zero, 1%, 0.02, etc.). For example, a routine-related profile for the specific user may be generated by populating the routine-related profile with initial values for routine-related aspects. Alternatively, the initial values for routine-related aspects in this example may be assigned confidence scores using any numbering system or combinations thereof.

User routine models include routine-related logic that defines a logical framework for determining routine-related inferences through evaluation of data associated with currently-sensed interaction data. In some implementations, routine-related logic includes one or more of the following probabilistic rule types: prediction rules, ranking rules, clustering rules, or classifying rules. Routine-related logic defines the logical framework by: mapping data associated with currently-sensed interaction data to each of the one or more routine-related features; prescribing relationships between the one or more routine-related features to determine routine-related inferences using data associated with currently-sensed interaction data; and, in some implementations, assigning routine-related weights to at least one routine-related feature. Routine-related weights are assigned to particular routine-related features based on a particular routine-feature's relative significance in determining (e.g. predicting the likelihood of) a routine-related inference. As such, user routine models and their determined routine-related inferences may be used to generate or update routine-related profiles for a specific user.

Currently-sensed interaction data can be received via one or more sensors associated with user devices and a routine-related inference can be determined through evaluation of data associated with that currently-sensed interaction data according to routine-related logic associated with the user routine model. In implementations, data associated with that currently-sensed interaction data includes one or more of the following: raw interaction data received from sensors, descriptive information associated with the raw interaction data, inference data determined from raw interaction data and/or descriptive information, or any combination thereof. As discussed in connection with routine inference engine 250 of FIG. 2, in implementations, routine-related inferences may be presented in various formats depending on type of routine-related logic used to determine a particular routine-related inference, such as classification labels, probability distribution functions, expected outcomes, outcome scores, and the like.

A routine-related profile for a specific user can be updated or initialized using the routine-related inference. In implementations where routine-related profile(s) have not been generated with initial values, routine-related inferences may be used as initial values to initialize the routine-related profile(s). In implementations where routine-related profiles are generated by populating the routine-related profile(s) with initial values determined using previously-sensed interaction data in populated interaction datasets, routine-related inferences may be reconciled with corresponding initial values. In these implementations, routine-related inferences are reconciled with corresponding initial values through replacement, averaging, weighted averaging, interpolation, extrapolation, and the like. In these implementations where confidence scores are assigned, confidence scores may be increased from previous values according to any of the implementations described herein.

One or more routine-related aspects may be provided for a specific user where a request is received for the one or more routine-related aspects for the specific user. The one or more routine-related aspects can be identified using routine-related profiles associated with the specific user, in response to receiving the request. The routine-related profiles being generated using interaction data according to any of the implementations described herein, such as described above. Further details of generating routine-related profiles are provided in connection with routine inference engine 250 of FIG. 2. The one or more routine-related aspects can be provided to the device, application, or service submitting the request.

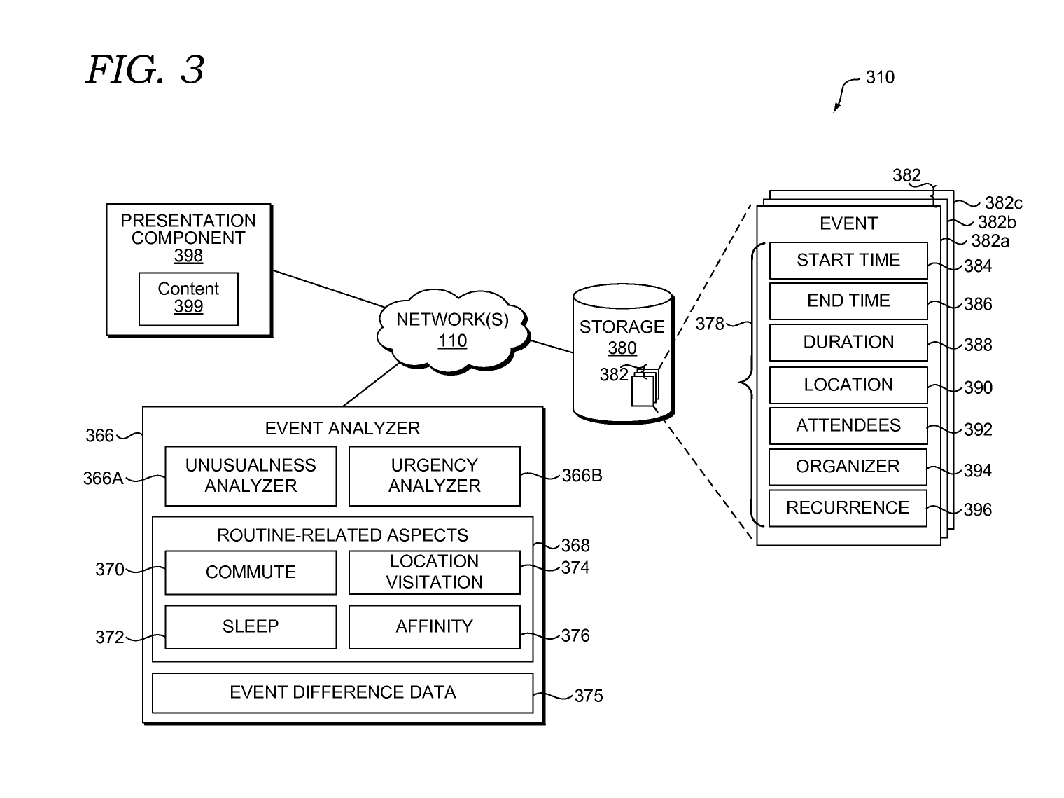

Having described an optional architecture and various methods for generating routine-related aspects of routines of users, in accordance with some implementations of the present disclosure, FIG. 3 is a diagram depicting an exemplary computing architecture suitable for analyzing events of users, in accordance with some implementations of the present disclosure. FIG. 3 shows event analyzer 366 configured to analyze one or more events of a user based on routine-related aspects of routines of the user and event attributes of the events. By analyzing events of users with respect to routine-related aspects, event analyzer 366 can access events for impact with respect to what is ordinary and expected in the users' everyday life.

Event analyzer 366 includes unusualness analyzer 366A and urgency analyzer 366B as subcomponents thereof. While unusualness analyzer 366A and urgency analyzer 366B are depicted as discrete components in FIG. 3, at least portions thereof may optionally be functionally integrated. Event analyzer 366 is configured to analyze the impact of changes to events in terms of unusualness and urgency. In particular, when one or more changes are made to an event, such as event 382a, event analyzer 366 utilizes unusualness analyzer 366A to quantify the impact of the change with respect to a difference in unusualness to the user caused by the change. In this way, the impact can indicate what changes are on the aggregate important and noteworthy to the specific user.

Event analyzer 366 utilizes urgency analyzer 366B to quantify the urgency that the user be notified of the change, such that the impact can be used to indicate what changes are currently important and noteworthy to the specific user. Thus, the impact may be used so that the most important changes to events can be determined and surfaced to the user and/or a suitable manner or time of surfacing the changes to the user can be determined.

In some implementations, unusualness analyzer 366A quantifies a difference in unusualness to the user caused by a change to an event as an unusualness difference score. The unusualness difference score can optionally be determined with respect to a change to an event by combining or comparing an initial unusualness score corresponding to the event prior to the change and an updated unusualness score corresponding to the event after the change. For example, the unusualness difference score may be calculated by subtracting one of the initial and updated unusualness scores from the other of the initial and updated unusualness scores. It will be appreciated that an unusualness difference score can be factor specific or a composite score for multiple factors such as the event overall. In various implementations, the absolute value of the calculation is utilized as the unusualness difference score. However, in other implementations, the unusualness difference score may be calculated more directly based on the changes made to the event.

As used herein, an unusualness score quantifies a level of deviation between one or more event attributes of one or more events (e.g., a single event) and one or more routine-related aspects of one or more modeled routines of one or more users (e.g., a single user). Where an unusualness score is based on a plurality of factors, or aspects of events, each factor (also referred to as a factor metric), may quantify a respective level of deviation between at least one event attribute and at least one of routine-related aspect of at least one modeled routine. An unusualness score for a factor, or aspect, of an event can also be referred to as a factor score. Multiple factor scores can be combined to quantify the overall or composite unusualness of an event, for examples as an overall or composite unusualness score. In some cases, in combining the factors, different factors may be assigned different weights in determining an overall or composite unusualness score. For example, a factor score may be multiplied by a weight value in calculating an unusualness score. At least some of the weight values may be machined learned and/or may be personalized to the user.

The unusualness difference score can quantify a change or difference in the level of deviation between the one or more event attributes of one or more events and the one or more routine-related aspects of the one or more modeled routines of the one or more users that is caused by a change to the one or more events (i.e., the magnitude of the change). It will be appreciated that unusualness difference scores may be calculated for each factor and/or overall events, which may be based on corresponding unusualness scores.

Also in various implementations, urgency analyzer 366B quantifies the urgency that the user be notified of the change as an urgency score. An urgency score may be generated for each factor and/or overall event. In various implementations, the urgency that a user be notified of a change to an event is based on a time of the event (e.g., a start time, end time, or time therebetween). For example, an urgency score may be based on an amount of time until an event is scheduled to occur after the change. The amount of time until an event may be measured from a current time available to event analyzer 366, such as from the server or user device, a predicted or predetermined time when content will be presented based on the unusualness scores, or another reference time. Events having times that are closer to the reference time may have a higher contribution to urgency than events farther from the reference time. In these cases, time may be factored into the urgency for an event in a way that is proportional to the time that event is scheduled to occur, with urgency for impending events being evaluated as more urgent than for distant events. Thus, for example, if an event were three hours away, changes to the event may typically be considered more urgent and more impactful than if the event were instead a week away.

Another example of a factor for urgency is whether the user is the organizer of the event. For example, where the user had organized the event, it may be more urgent for the user to become aware of changes to the event. A further example of a factor for urgency is based on the importance of one or more of the attendees of the event. For example, event analyzer 366 may determine that the urgency is higher by analyzing relationships between the user and one or more of the attendees. Event analyzer 366 may calculate higher urgency the higher the determined importance levels of the relationships are to the user (e.g., individually or on aggregate). Thus, for example, a change to an event where an attendee is the CEO of the company where the user works may be considered more urgent than if the attendees of the event were all at similar positions as the user in the company.

The urgency score may further use as a factor the user's current location or expected/predicated location when the content based on the impact scores is to be presented or when the change is detected. An urgency score for an event may be based on a distance between the reference location of the user and the location of the event. Events having locations that are farther from the reference location may a higher impact on urgency than events closer to the reference location.

Event analyzer 366 is operable to combine the difference in unusualness caused by a change to an event with the urgency of notifying the user about the change so as to determine the impact of the change. In implementations where separate unusualness difference scores and urgency scores are employed, an impact score can be calculated from at least an unusual difference score (e.g., an overall score or factor specific score) multiplied, or otherwise weighted or combined with a corresponding urgency score. In some implementations, the unusualness difference scores and urgency score are not separately calculated, as described above. However, employing separate scores can reduce the complexity in tuning the urgency and unusualness.

In some cases, event analyzer 366 analyzes unusualness and resultant impact with respect to a particular user, such as any of the attendees of an event. In addition, or instead, event analyzer 366 may make assessments based on the aggregate unusualness and impact for multiple users, such as each attendee of an event. In one exemplary approach, impact could be separately assessed to generate an impact score for each particular user, which may be combined to into an aggregate impact score (e.g., using an average). As another example, the scores that contribute to an impact score may be aggregated as part of generating the impact score for multiple attendees.

By way of example, FIG. 3 shows events 382 of a user, such as one of the users having an associated user profile 230 in FIG. 2. As used herein, an event of a user can refer to an event associated with the user. For example, the user may be an attendee and/or organizer of the event. In some cases, an event can be generated using scheduling software, such as a calendar application. In various implementations, the event may be analyzed for unusualness while the event is being generated (e.g., while a user is inputting event attributes to the scheduling service), after the event is generated (e.g., after the event attributes are persisted or saved with respect to the event), and/or after one or more event attributes of the event are changed. When an event is changed, any changes may be analyzed individually and/or collectively with respect to unusualness and/or impact.

In various implementations, events may be generated using automated calendaring software that can employ e-mail or other mechanisms to invite one or more users to the events, or meetings. More traditional examples include Microsoft® Outlook® and Lotus Notes®. However more recent examples can be found as primarily cloud based services and/or as services integrated into mobile phones. For example, such applications are often provided as stock or default applications of an operating system, such as mobile operating systems including versions of Windows® Phone, Android™, or iOS™, or desktop operating systems, such as versions of Windows® or Mac OS®. However, these applications may also be provided by third parties to the operating system provider. Further, an event may be planned and/or analyzed cross-platform and/or cross-application. As an example, Google Sync and/or Yahoo Sync can be employed to import calendar events into a Windows Phone calendar. Events 382 can be examples of any of the aforementioned events, and each comprise one or more event attributes, such as event attributes 378 of event 382a.

In some cases, to schedule a meeting, an organizer may use a service to send an invitation to one or more invitees. The invitation typically indicates one or more event attributes, such as event attributes 378, that may be set by the organizer or another user, such as a date and time for the meeting, a location for the meeting, whether the meeting is recurring or when the meeting will recur, and comments. The service typically tracks responses from the invitees, such as whether invitees accept, reject, tentatively accept, or propose a new time or location. Based on the responses, the service can update or set one or more event attributes, such as by maintaining a list of attendees (e.g., planned attendees) for the event. Further, the service may automatically add the meeting as a calendar event, or entry, in a personal calendar of each of the users. Often one or more event attributes may be modified (or attributes may be added or removed) by one or more users after being initially set by the original organizer or another user.

Thus, in various implementations, at least some of the event attributes of an event can correspond to information entered by one or more users in planning, scheduling, or changing the event, such as by one of the attendees and/or the organizer of the event. However, in some implementations, at least one of the event attributes of an event may be inferred. Furthermore, in some cases, at least one event itself may be inferred to exist and/or changes to that event and/or event attributes thereof. These inferences may be made using system 200 of FIG. 2. For example, an event itself may be part of a routine of a user and event attributes could be routine-related aspects. Examples of event attributes of an event are shown with respect to event 382a in FIG. 3. Exemplary event attributes include start time 384, end time 386, duration 388, location 390, attendees 392, organizer 394, and recurrence 396. However, not all event attributes may be included and other event attributes may be employed in various implementations of the present disclosure. Further, it will be appreciated that any two of start time 384, end time 386, and duration 388 may be used to derive the other.

Start time 384 corresponds to a planned or expected start time of event 382a, end time 386 corresponds to a planned or expected end time of event 382a, duration 388 corresponds to a planned or expected duration of event 382a, location 390 corresponds to a planned or expected location for event 382a to take place, attendees 392 correspond to a set of people or contacts expected or planned to attend event 382a, organizer 394 corresponds to the organizer of event 382a, and recurrence 396 corresponds to an indicator of whether or not event 382a is a repeating event as opposed to a one off event. In the present example, event 382a corresponds to an event entry associated with a user (e.g., in a calendar service or application). However, in other cases, event 382a can correspond to an event being planned or generated and may not explicitly be associated with a particular user.

Event attributes of an event act to define the event, and may capture various unusual aspects or features of the event. Furthermore, modifying, adding, or removing these event attributes can have an impact the lives of the users associated with the event. However, event attributes often lack context as to the significance of the attributes in the lives of those impacted by the event. Therefore, event attributes alone may be unsuitable for properly determining the unusualness of an event and the impact of changes to event attributes. In various implementations, event analyzer 366 can employ routine-related aspects of a user to provide context to the event attributes so as to accurately determine the usualness of the event for the user and the resultant impact of changes to the event attributes for the user. Thus, the notions of unusualness and impact can be personalized to users' lives and routine behaviors.

Examples of routine-related aspects include routine-related aspects 368 in FIG. 3. Routine-related aspects 368 comprise information that is inferred from user patterns of interaction data. For example, in some implementations, one to all of routine-related aspects 368 can be provided to event analyzer 366 from recommendation engine 260 of FIG. 2. For example, routine-related aspects 368 may be provided using client-side service interface 261, server-side service interface 263, and/or cloud-based service interface 265. In some cases, event analyzer 366 may actively request information from recommendation engine 260. In other cases, the information may be provided to or made available to event analyzer 366 in a passive or unsolicited manner.

Each of the routine-related aspects may be inferred from one or more corresponding routines (e.g., routine models) being tracked, trained, and analyzed by routine model engine 240. Further, each routine-related aspect may be inferred, or predicted, by routine inference engine 250 for a specific user. In particular, the specific user can correspond to an attendee of an event for which unusualness is being determined. The routine-related aspects employed by event analyzer 366 can comprise any combination of the various metrics, scores, or values associated with routine-related inferences, such as confidence scores, variance metrics, central tendency values, probability distribution functions, and the like. Event analyzer 366 can process the routine-related aspects to infer the unusualness of an event for the user and/or a difference in unusualness caused by a change to the event. In particular, event analyzer 366 may employ the routine-related aspects and event attributes of the event in order to characterize unusualness of the event and the impact of a change to the event. Examples of routine-relate aspects include commute-related aspects 370, sleep-related aspects 372, location visitation-related aspects 374, and affinity-related aspects 376.

As indicated above, each event may be assigned an unusualness score generated by analyzing routine-related aspects of routines of a user with respect to event attributes. Further described above, the impact of a change to an event to the user can be based on analyzing the routine-related aspects of the routines of the user with respect changes made to the event attributes (e.g., based on the unusualness score before and after the changes). Unusualness may be based on various factors, which combine to quantify and characterize the unusualness of an event. Further described above, in some cases, each factor is analyzed separately to generate a respective factor score and/or unusualness difference score for a factor, which each may represent one criteria utilized in analyzing the unusualness of an event or impact of a change to the event and may correspond to a respective factor metric. The various scores can be combined to generate an unusualness score and/or overall unusualness difference score. Various factors are described below with respect to factors scores. However, it will be appreciated that the following considerations also apply to unusualness difference scores for the factors.

One such factor in determining unusualness can be based on commute patterns of a user. The commute patterns of a user may be captured by commute-related aspects 370 of one or more commute-related routines of the user and analyzed with respect to one or more event attributes of an event. As an example, a commute-based factor that can contribute to the unusualness of an event may be based, in part, on overlap between the event and one or more known commutes of the user (e.g., a commute modeled by routine model engine 240). A degree of the contribution (e.g., the factor score) to overall unusualness of an event (e.g., the unusualness score) can be based on the amount of overlap between the event and a commute. For example, the factor score may be at a minimum (e.g., no contribution) where there is no overlap between the event and a commute, and increase with the amount of overlap, such that the contribution may be at a maximum for complete overlap. Thus, as a specific example, where a commute is from 9:15 AM to 10:00 AM and the event start time is 9:45 AM with a duration of one hour, the factor score may be lower than where the event start time is 9:10 AM.

In some implementations, a commute-based factor can be determined based on event attributes that indicate the start time, end time, and/or duration of the event. Further, a commute-based factor can be based on routine-related aspects of a commute including a start time, and end time of a modeled commute of the user. Optionally, the commute-based factor may further consider variance metrics of the start time and the end time (e.g., standard deviations). In considering variance metrics, the amount of overlap may be determined based on the variance of the start time of the commute and the variance of the end time of the commute. For example, in determining overlap, the start time may be adjusted forwards by the variance metric (e.g., one standard deviation) associated with the start time, and the end time may be adjusted backwards by the variance metric (e.g., one standard deviation) associated with the end time. Further, confidence scores associated with the routine-related aspects can optionally be used to adjust the degree of the commute-based factor, with lower confidence scores decreasing the factor score.

Another such factor in determining unusualness of an event can be based on sleep patterns of a user. The sleep patterns of a user may be captured by sleep-related aspects 372 of one or more sleep-related routines of the user and analyzed with respect to one or more event attributes of an event. As an example, a sleep-based factor that can contribute to the unusualness of an event may be based, in part, on overlap between the event and one or more known sleep schedules of the user (e.g., a sleep schedule modeled by routine model engine 240). A degree of the contribution (e.g., the factor score) to overall unusualness of an event (e.g., the unusualness score) can be based on the amount of overlap between the event and a sleep schedule. For example, the factor score may be at a minimum (e.g., no contribution) where there is no overlap between the event and the sleep schedule, and increase with the amount of overlap, such that the contribution may be at a maximum for complete overlap.

In some implementations, a sleep-based factor can be determined based on event attributes that indicate the start time, end time, and/or duration of the event. Further, a sleep-based factor can be based on routine-related aspects of the sleep schedule including a start time (i.e., bedtime), and end time (i.e., wakening time) of a modeled sleep schedule of the user. Optionally, the sleep-based factor may further consider variance metrics of the start time and the end time (e.g., standard deviations). In considering variance metrics, the amount of overlap may be determined based on the variance of the start time of the sleep and the variance of the end time of the sleep. For example, in determining overlap, the start time may be adjusted forwards by the variance metric (e.g., one standard deviation) associated with the start time, and the end time may be adjusted backwards by the variance metric (e.g., one standard deviation) associated with the end time. Further, confidence scores associated with the routine-related aspects can optionally be used to adjust the degree of the sleep-based factor, with lower confidence scores decreasing the factor score.

Yet another such factor in determining unusualness of an event can be based on location visitation patterns of a user. The location visitation patterns of a user may be captured by location visitation-related aspects 374 of one or more location visitation-related routines of the user and analyzed with respect to one or more event attributes of an event. As an example, a location visitation-based factor that can contribute to the unusualness of an event may be based, in part, on a frequency of the user visiting a modeled location or venue that is at or near a location of the event (e.g., visits to a location or venue modeled by routine model engine 240).

In some implementations, event analyzer 366 is configured to determine a location-visitation based factor based on a comparison between the location of the event with the location of one or more visited venues, or locations, modeled by routine model engine 240. For example, the location can be compared to one or more visited locations and the location visitation-based factor may correspond to the probability that the location of the event is one or more of the visited locations. In some cases, the factor score can be greater the farther the location of the event is to the location of the one or more visited locations, such as the closest visited location. The minimum score may be where the location of the event is substantially at the location of the visited location and may increase up to a maximum at a distance from the visited location (e.g., a predefined distance). As an example, the locations employed may each comprise location coordinates used in determining distance, such as a longitude and a latitude, and may be based on GPS coordinates. Thus, where the event is at or near a routinely visited venue or location of the user, the event may not be considered particularly unusual with respect to a location visitation-based factor.

The location of the event can be, for example, location 390 of the event attributes of event 382a. In some cases, the location coordinates utilized by event analyzer 366 in determining the unusualness of an event are explicit or implicit in the event attributes stored in association with the event. For example, an event scheduling service may allow organizations or users to explicitly provide longitude and latitude for conference rooms and/or other resources. As another example, location 390 could comprise an address entered or selected by a user, such as an attendee of the event. Such an address can implicitly be associated with location coordinates that event analyzer 366 may look up using a geo-location service. As a further example, location coordinates may be inferred from location 390. For example, previous events may have used the location of the meeting or text comprising characters corresponding to the text of the current location. Based on location coordinates (and/or other sensor data) extracted from a user device during previous events, event analyzer 366 may infer that the location coordinates correspond to the location of the current event.

In some implementations, event analyzer 366 provides a time based on the event to recommendation engine 260. For example, the start time, the end time, or a time between the start and end times may be provided to recommendation engine 260. Based on the time, routine inference engine 250 can predict the location of the user (e.g., the location of the user). For example, based on patterns formed by spatial-temporal data points collected in association with the user, routine inference engine 250 may provide location visitation-related aspects 374 comprising one or more locations and probabilities that the user is at or near the one or more locations for the given time (or time range). Event analyzer 366 may select the closest predicted location to the location of the event and generate the factor score based on the distance of the event location from the event. Such analysis may optionally factor in the probabilities association with the locations. For example, the factor score may be weighted by the probability of the predicated location. As another example, more probable locations may be weighted more heavily than less probable location in selecting the predicated location to compare to the location of the event.

In addition, or instead, the location visitation-based factor may be generated by event analyzer 366 providing the location of the event to routine inference engine 250 with the time based on the event and receive a probability that predicts whether the user will be at the location during the time. The probability can be used to determine the factor score, for example, such that a higher probability lowers the unusualness with respect to the factor.

An example of how routine inference engine 250 may predict one or more locations of the user for purposes of location visitation-based factors is provided below. However, other approaches may be employed. In some implementations, a confidence score, or probability score, can be generated for a corresponding location that is indexed by a temporal interval of varying resolution. For time stamps of spatial-temporal data points (e.g., location coordinates and a corresponding time stamp), examples of temporal intervals include Tuesday at 9 AM, a weekday morning, and a Wednesday afternoon. In making such a determination, a temporal interval may correspond to a time of the event provided by event analyzer 366. The confidence score may be computed by applying a Dirchlet-multinomial model and computing the posterior predictive distribution of each period histogram. In doing so, a prediction for each bin in a particular histogram may be given by:

$${x}_{i} = \frac{{α}_{0} + {h}_{i}}{{\sum }_{i}^{K} ( {α}_{0} + {h}_{i} )} .$$

Where K denotes the number of bins, α₀ is a parameter encoding the strength of prior knowledge, and i*=arg maxᵢxᵢ. Then, the pattern prediction is the bin of the histogram corresponding to i* and its confidence is given by xᵢ*. As an example, consider a histogram in which morning=3, afternoon=4, and evening=3. Using α₀=10, the pattern prediction is afternoon, and the confidence score is

$$\frac{10 + 4}{( 10 + 3 ) + ( 10 + 4 ) + ( 10 + 3 )} = \frac{14}{40} \approx 0.35 .$$

In accordance with various implementations, more observations results in an increased confidence score, indicating an increased confidence in the prediction. As an example, consider a histogram in which morning=3000, afternoon=4000, and evening=3000. Using a similar calculation, the confidence score is

$$\frac{4010}{10030} \approx 0.4 .$$

Also, in some implementations, a confidence score can be generated for a corresponding tracked variable that is indexed by a period and a number of time stamps. Examples include 1 visit per week, and 3 visits every 2 weeks. Using a Gaussian posterior, a confidence score may be generated for a pattern for every period resolution, denoted as j. This may be accomplished by employing the formula:

$$\hat{{μ}^{( j )}} = λ ( \frac{1}{{N}^{( j )}} {\sum }_{i}^{{N}^{( j )}} {w}_{i}^{( j )} ) + ( 1 - λ ) {μ}_{0} , where λ = \frac{{σ}_{0}^{2}}{\frac{{σ}^{2}}{{N}^{( j )}} + {σ}_{0}^{2}} .$$

In the foregoing, σ² is the sample variance, and σ₀² and μ₀ are parameters to the formula. A confidence score can be computed by taking a fixed interval around the number of time stamps prediction and computing the cumulative density as:

$${conf}_{j} = P ( \vert x - \hat{{μ}^{( j )}} \vert < a ) = {\int }_{\hat{{μ}^{( j )}} - a}^{\hat{{μ}^{( j )}} + a} 𝒩 ( x \vert \hat{{μ}^{( j )}} , {\hat{σ}}^{( j )} ) , where {\hat{σ}}^{( j )} = \frac{1}{\frac{{N}^{( j )}}{{σ}^{2}} + \frac{1}{{σ}_{0}^{2}}} .$$

As an example, consider the following observations: w₁⁽¹⁾=10, w₂⁽¹⁾=1, w₃⁽¹⁾=10, w₄⁽¹⁾=0, w₁⁽²⁾=11, and w₂⁽²⁾=10. N⁽¹⁾=4 and N⁽²⁾=2. Using μ₀=1 and σ₀²=10, μ⁽¹⁾=4.075, and conf₁=0.25. Furthermore, μ⁽²⁾=10.31 and conf₂=0.99. In the foregoing example, although fewer time stamps are available for two week periods, the reduced variance in the user signals results in an increased confidence that a pattern exists.

Having determined that a pattern exists, or that the confidence score for a pattern is sufficiently high (e.g., exceeds a threshold value), routine inference engine 250 may generate an inference, such as identify that a location or venue is routinely visited by a user. A standard deviation may be established by mapping a function to the time stamps of the spatial-temporal data that forms the pattern, such as a Gaussian function, or bell curve, as an example.

Routine inference engine 250 may further employ place prediction, which may be implemented using the histogram model indexed using the temporal interval, as described above. The temporal interval be provided by event analyzer 366, as described above. Using the time, the histogram model may be applied to each known place or location. Each place of these places can yield a probability that estimates a portion of visits to the place at the time:

$$P ( Place = p \vert time = t ) = \frac{P ( time = t \vert Place = p ) P ( Place = p )}{{Σ}_{p} , P ( time = t \vert Place = {p}^{′} ) P ( Place = {p}^{′} )} .$$

Quantity time=t|Place=p) is the histogram model described above. P(Place=p) is the prior probability of being in place p. The resolution of time t is relaxed in from narrow to broad (e.g., Tuesday At 9 AM=>Weekday Morning) until the above quantity surpasses a threshold, in which case our model predicts place p. Where place p corresponds to a the location of the event, it may be inferred that the event is not highly unusual with respect to location and/or a location or candidate venue corresponding to place p can have an increased confidence, or probability score as being the predicted location of the user.

A further factor in determining unusualness of an event can be based on affinity patterns of a user. In some implementations, the affinity patterns of a user may be captured by affinity-related aspects 376 of one or more affinity-related routines of the user and analyzed with respect to one or more event attributes of an event. By utilizing an affinity-based factor, event analyzer 366 can assess the unusualness of an event with respect to the participants/attendees of the event. As an example, an affinity-based factor that can contribute to the unusualness of an event may be based, in part, on affinities between the user and one or more attendees of the event that correspond to contact profiles, or users, being tracked as part of one or more affinity-based routines of the user (e.g., a pattern of user interaction with a contact profile modeled by routine model engine 240).

In some implementations, event analyzer 366 provides a list of the attendees of the event, such as attendees 392, to recommendation engine 260. Recommendation engine 260 can provide the list to routine inference engine 250 for generating affinity scores with respect to the list of attendees. One or more affinity scores may be provided to event analyzer 366 for generating a factor score for the affinity-based factor. The one or more affinity scores may be an aggregate affinity score for the list of attendees, or an affinity score may be provided for each attendee, by way of example. Affinity scores correspond to a quantified level of association between a user and one or more other users, or contacts. In particular, the attendees may be mapped to one or more contact entries that are being tracked by routine model engine 240 with respect to the user. In some cases, the contact entries correspond to entries in the user's contact book, such as the user's mobile contacts, and/or email contacts. Each contact entry may include a corresponding name, and one or more street addresses, e-mail addresses, phone numbers, and the like. In some cases, the list of attendees may comprise the contact entries of the attendees or and/or indicators thereof, for example, where the attendees for events are generated from a contact book shared with routine model engine 240. In other cases, routine inference engine 250 may infer the contacts from information provided in the list of attendees, such as names, e-mail addresses, and the like.

An affinity between a user and an attendee can be based on various tracked interactions between the user and the contact corresponding to the attendee. Examples of interactions that can increase the affinity include e-mails to and or from the contact, text messages to and/or from the contact, phone calls to and/or from the contact, other sensor data associating the user with the contact, and quantities of any of the forgoing. In some cases, the affinity can be based on other events, or meetings, such as past events where the user and the contact were both attendees. Further, invites to events to or from the contact that are associated with the user may increase the affinity. In some cases, affinity is discounted based on the recency of the detected interaction. For example, more proximate interactions may increase affinity to a larger degree that less proximate interactions. The affinity need not be solely based on detected or identified interactions between the user and the contact. In particularly, an information associating the user with the contact can be employed. As an example, an organization chart that includes the user and the client as employees could be used.

In some implementations, the affinity of the attendees is further based on context. For example, text generated and/or extracted from the title of the event and/or other event attributes could be provided by event analyzer 366, such that affinities can be assessed with respect to context indicated by the text.

A factor score for an affinity-based factor can be generated based on the one or more affinity scores. It will be appreciated that various approaches may be employed. In general, higher affinity scores indicate the attendees are less unusual for the user, thereby resulting in a lower contribution to the unusualness of the event. Other factors may include the number of attendees having an affinity score that exceeds a threshold value of having low affinity to the user. However, in some cases, the affinity scores may be aggregated to generate a factor score, for example, as an average of the affinity scores.

In addition to one or more routine-related aspects of tracked routines of users, event analyzer 366 may use one or more other factors to adjust the unusualness score, urgency score, and/or or impact score. One such example includes whether the event is a recurring event. For example, recurrence 396 may indicate that the event is a recurring event. As used herein, a recurring event corresponds to an event that is scheduled for more than one time period, and may repeat on a weekly, monthly, or daily basis. Where the event is a recurring event, event analyzer 366 may discount, or otherwise adjust the unusualness score or another of the scores. Another example of a non-routine based factor includes whether the user is the organizer of the event. For example, organizer 394 may indicate that the event is organizer by the user. Where the user is the organizer of the event, event analyzer 366 may adjust the unusualness score or another score.

Yet another non-routine based factor is the duration of the event. For example, the duration of the event may be analyzed with respect to one or more additional or other events associated with the user, such as events 382 to determine whether the duration is longer or shorter than the aggregated duration of those events. As an example, the duration of the event can be compared to the average duration of the events. The closer the duration of the event to the average duration, the less likely the duration of the event is to increase an unusualness score or other score. In some cases, the average duration includes events within a time period following the event, such as over the next two weeks. The time period may further include one or more previous events, such as events for the previous day or two. In addition, the duration of the event being analyzed may be included in the average or aggregate duration. The average duration need not be limited to the time period and could be based on a rolling average, or otherwise account for historical event durations.

Various factors have been described above which can be combined by event analyzer 366 to determine the level of unusualness for an event and/or the difference in the unusualness of the event to the user caused by a change to the event. The unusualness may be based on an unusualness metric and/or one or more factor metrics that are combined with an urgency metric to form an impact metric, which can be used to assess the impact of one or more changes to any of the various events with respect to one or more users. Thus, the relative impact of one or more changes can be compared to the relative impact of one or more other changes within the same event and/or amongst multiple events.

As described above, in various implementations, event analyzer 366 quantifies the impact of a change to an event to a user based on a difference in the unusualness of the event to the user caused by the change, combined with the urgency that the user be notified of the change. In many cases, the magnitude of the difference in the unusualness of the event (e.g., the absolute value described above) is sufficient to accurately reflect the impact of a change. However, in some cases, the magnitude may be small for a change in unusualness even through the change is important to the user. As an example, suppose location 390 of event 382a is initially at an unusual location as quantified by a location-visitation based factor, or other location based factor. Where location 390 is changed to another location of similar unusualness, the magnitude for that factor will be low, which can result in a low magnitude and impact score even though it might be important for the user to know about the new location, especially because it is unusual.

Thus, in some implementations, the impact for a change may be adjusted to more accurately reflect the impact of the change based on any of various approaches described below. In some approaches, the adjustment can be reflected in the impact score calculated for a change to an event and/or factor thereof. In addition, or instead, some approaches may detect and map certain conditions of the change to impact separate from the impact scores themselves, such as in determining which changes should be surfaced to the user.

In various approaches, the impact could be based, at least in part, on the initial unusualness score for the change being analyzed with respect to impact. In doing so, the impact metric might be formulated to ensure that events and/or factors thereof that were highly unusual prior to and after being changed still have a high contribution to impact. As an example, the magnitude of the difference in unusualness for a change may be multiplied by the initial unusualness score (or another coefficient based on the initial unusualness score) for the event and/or factor being analyzed with respect to impact. Thus, the impact may be increased for events or factors that were initially highly unusual as compared to those that were initially of low unusualness. In some cases, this boost to impact may be applied using one or more threshold values. For example, threshold values may be used to set the boundaries conditions for applying boosts to the impact. An example would be to apply the boost in cases where both initial and prior unusualness scores for a change are sufficiently high.

In some approaches, the impact is determined based on identifying the highest contributing factor to unusualness prior to and/or after a change to an event. This approach may be especially suitable where impact is being determined for multiple changes made to the event using a composite unusualness score. As an example, a boost to impact may be applied based on determining that the one or more event attributes corresponding to that highest contributing factor has changed and/or that the highest contributing factor is different after the change. Thus, for example, where the highest contributing factor corresponds to a location based factor of an event prior to and after a change to the event, the impact may be boosted where the location is changed as compared to where it remains the same. As another example, where the highest contributing factor corresponds to a location based factor of an event prior to a change to the event and corresponds to an affinity based factor after the event, the impact may be boosted as compared to where the highest contributing factor remains the location based factor (and possible where the location remains the same). It will therefore be appreciated that any combination of the various approaches or other approaches may be employed to adjust the magnitude of the difference so as to identify truly impactful changes to events.

In some implementations, events can be stored in storage 380, which may be the same or different than storage 220 in FIG. 2. In some cases, storage 380 is located on the user device, such as user device 102a, or is otherwise stored in association with a user. However, storage 380 may instead be located on a server, such as server 106, while the user device may retain one or more local copies of any of the various data included in storage 380. The various events can be aggregated from various scheduling and event tracking services, such as has been described above. A service of the operating system, or other service, which may be on the user device, can listen for changes to the events, such as modifications to existing events, added events, or removed events, that may impact the unusualness of one or more events. Based on detecting one or more changes, the listener may provide a notification to cause event analyzer 366 to update unusualness scores for the events and/or determine the impact of the changes to the events.

In some cases, when changes are detected, the listener may cause the changes to be uploaded to a server, such as via recommendation engine 260, for further processing. For example, event analyzer 366 optionally may at least partially be integrated into routine inference engine 250 in a server (e.g., server 106) and external to the user device. Thus, at least some of the functionality of event analyzer 366 may be cloud based. However, in other implementations, at least some of the functionality of event analyzer 366 may be on a user device of the user for which events are being analyzed. In some cases, changes to events may be evaluated by event analyzer 366 periodically, such as on a daily cycle. However, changes may be evaluated at other intervals, such as each time a change is detected and/or based on triggering the presenting of service content to the user (e.g., based on a user action in a UI of the user device, a current time, and/or other criteria).

In various implementations, a user may change one or more event attributes of one or more events using a user device, such as user device 102a, by interacting with a calendar application or service, as examples. The calendar application or service, or another application or service (e.g., on the user device or a cloud service) can detect the change and a notification message can be transmitted to a server (e.g., from the user device or cloud service), such as server 106 in FIG. 1 to for processing of the change. In some implementations, the notification message comprises one or more changes made to one or more events. For example, the notification message may indicate which event attributes of which event(s) changed and values representing those changes for use in determining impact (e.g., old and/or new values of event attributes and/or delta values for event attributes). The notification message may further indicate a time that the event(s) were changed.

In some implementations, determining impact is synchronous with communication with the device providing a notification message. However, in others, this process may be asynchronous, which can allow for power savings to the device by allowing the connection to close after sending the notification message without waiting for an acknowledgement from the server. The acknowledgment may later be pushed, for example, by way of a success message that may optionally include one or more impact scores or other instructions or an error message that may cause the user device to resend the notification message. Where the communication is with the user device, the battery life of the user device may be significantly improved.

In some implementations, event analyzer 366 may determine impact for multiple changes to multiple events and/or factors thereof. Service content can be provided to a user associated with the events based on one or more impact scores assigned to one or more of the changes. The relative nature of the impact scores can allow for the system to determine which changes to events are surfaced to the user and/or a suitable manner or time for surfacing the changes to the user. This can improve the performance of the system by providing criteria for refraining from surfacing relatively insignificant changes to the user, and can further improve the user experience and interface.

Thus, for example, having determined one or more impact scores for one or more changes, content (e.g. content 399) may be presented to the user based the one or more impact scores using presentation component 398. The content may be presented, for example, on any combination of user devices 102a and 102b through 102n. In this capacity, presentation component 398 may employ any of the various event attributes of the events, impact scores of the changes, unusualness scores of the events, and/or routine-related aspects utilized to generate those scores, as well as other data. Presentation component 398 can determine when and/or how content is presented to a user. Presentation component 398 can further determine what content is provided to the user.

In some implementations, event analyzer 366 may generate contextual information corresponding to a change to an event and/or one or more factors thereof. In some cases, generating the contextual information comprises assigning one or more categories to one or more changes. In particular, event analyzer 366 may assign one or more predetermined categories to a change. As one example, changes may be categorized as impactful based on the impact score corresponding to the change exceeding a threshold value. Optionally, such a categorization may also consider any of the various features of the event prior to and/or after the change to map features and impact scores to categorizations. Examples of features have been described above and include whether the unusualness score for the change increased, decreased, or remained substantially the same as a result of the change. Another example includes the direction of the change to the unusualness score caused by the change to the event. In some implementations, especially notable and/or urgent changes may be categorized as highly impactful. For example, changes may be categorized as impactful based on an impact score exceeding a first threshold value, and highly impactful based on an impact score exceeding a second threshold that is greater than the first threshold.

As a further example of a categorization, the categorization could indicate the highest contributing factor of the impact score and/or one or more scores (e.g., unusualness scores) utilized to determine the impact score. For example, of the various factors utilized in determining a composite unusualness score and/or a composite unusualness difference score, one of the factors may be the highest contributor to the overall score. This factor may be categorized as the highest contributing factor for that score. As an example, where only a location of an event changes, a location based factor may be identified as the highest contributing factor to a composite unusualness difference score for the change. The categorization of a highest contributing factor can be determined by ranking the contributions of the factors that contribute to a score. A similar approach could be used to categorize a lowest contributing factor or otherwise generate a categorization indicative of the ranking. In some cases, a categorization could indicate whether the highest contributing factor remained the same or changed as a result of a corresponding change to an event. From the forgoing it will be appreciated that many factors and conditions thereof may be analyzed in assigning categories including factor scores, unusualness difference scores, event attributes, and/or routine-related aspects utilized in determining the scores.

Presentation component 398 may utilize the contextual information in deterring when and/or how content is presented to a user and/or what content is presented to the user. For example, in some cases, presentation component may display or otherwise present an indicator of the highest contributing factor to the user in association with the event and/or other content presented based on an associated impact score. It is noted that categorizations may comprise various levels of granularity. For example, an indication of a highest contributing factor may further indicate a more specific aspect or reason associated with the contribution of the factor. As an example, the indication or categorization may not only indicate that an event is of an unusual duration, but may further indicate that the event is unusually long or unusually short. Other examples of contextual information include confidence scores, variance scores, and other information utilized to generate an unusualness score.

In some implementations, one or more of the categorizations may be associated with one or more actions that may be taken by presentation component 398 and/or content that may be presented to the user. For example, each categorization may have a different set of associated actions and/or content. Many of these sets may be directed toward preparing the user for scheduled events, such as by offering information for the user to study that corresponds to an event, or to offer to aid the user in making or altering arrangements (e.g., scheduled items, scheduled alerts, travel arrangements, reminders) to facilitate the user's participation in the event or otherwise manage the impact of the event.

As an example, based on an impact score being sufficiently high and/or categorized as highly impactful, the change may be presented automatically to the user in an active manner to quickly notify the user of the change. The notification could be in the form of any combination of messages made available to one or more user devices associated with the user. Examples include calling one or more user devices, sending an e-mail to an account associated with the user, texting a phone number associated with the user, and/or sending a push notification, a toast notification, or other alert to one or more user devices.

As a further example, certain categorizations may correspond to an interface for modifying arrangements that were previously made for the event. For example, prior to the event changing, the system may have previous presented executed a set of actions such as by assisted the user in planning for an event based on determining that the event was sufficiently unusual (e.g., based on an unusual score corresponding to the event). The set of actions may have corresponded to a factor of the unusualness score, such as the highest contributing factor. Presentation component 398 may detect that the factor has changed, and based on detecting that change, may perform a new set of actions, such as offering to modify the previous arrangements made in planning for the unmodified event.

Thus, for example, where the factor is a location-visitation based factor, presentation component 398 may present content that offers to reschedule travel time that was scheduled before and/or after a meeting for the user (e.g., in the users calendar). As another example, presentation component 398 may present content that offers to cancel or reschedule an alarm for the user. For example, the alarm may have initially been set prior to the user's typical wakening time based on the factor being a sleep-based factor indicating a time of the event was initially prior to or sufficiently close to the user's typical wakening time. Presentation component 398 may present content that offers to cancel the alarm, or reschedule the alarm, such as by moving the alarm back to its original time based on a change to one or more event attributes corresponding to the factor. Additionally, in the example above, any of those various plans or arrangements may be made without regard to previously made arrangements based on the factor or categorization of a change.

In some implementations, presentation component 398 selects one or more events and/or changes to events to present to the user from a plurality of events associated with the user based, at least in part, on the impact scores of the events. For example, one or more of the events and/or changes having the highest impact scores may be presented to the user. As described above, in some cases, a change may be categorized as impactful by event analyzer 366 based on the impact score of the change exceeding a threshold value. One or more events and/or changes (or other content) may be presented to the user based on whether the changes are categorized as impactful.

Various scores used to determine which events, changes, or other content to display to the user can be aggregated into a combined score. The changes may be ranked by the combined score and one or more of the change, events corresponding thereto, or other content associated therewith, may be selected for display (e.g., the top scoring change or changes). In some cases, the content may only be presented where the combined score exceeds a threshold value. Further, for some manners of presentation, the events being considered in the ranking may be for events classified as unusual after the change.

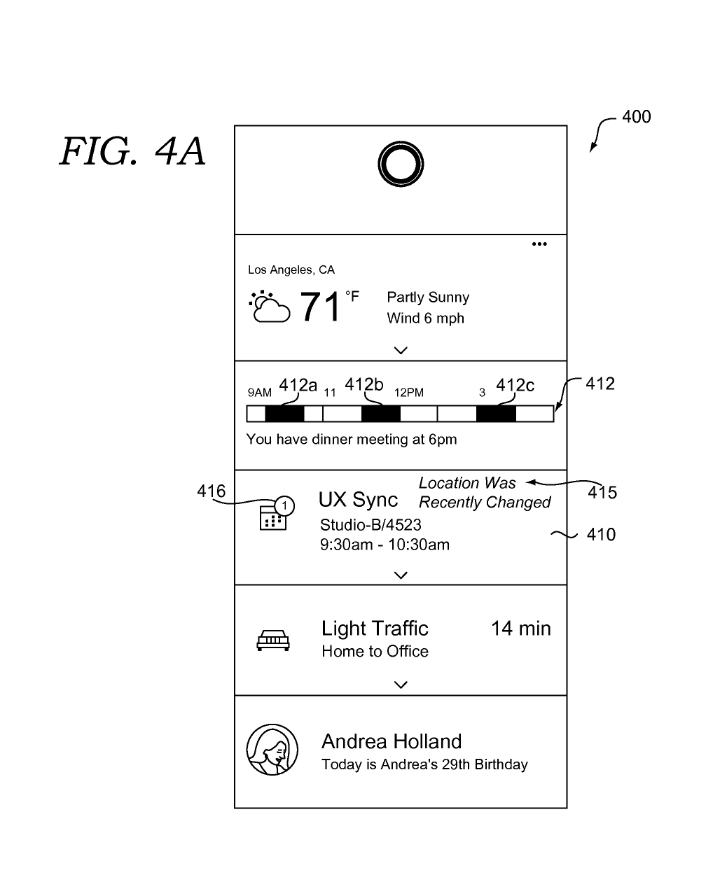

Referring now to FIGS. 4A and 4B, FIGS. 4A and 4B show exemplary content that can be presented to a user based on impact scores of one or more changes of one or more events associated with a user (e.g., on a user device, such as a mobile phone). In particular, FIGS. 4A and 4B show content 400, at least some of which may be provided by presentation component 398 based on impact scores. FIG. 4A corresponds to a condensed view of content 400 and FIG. 4B corresponds to an expended view of content 400 that may be presented based on clicking or tapping on pane 410 of content 400, as shown. Content 400 can comprise a summary report on events scheduled for the user. Content 400 comprises event schedule 412 of the user. Event schedule 412 indicates start and end times of events 412a, 412b, and 412c in a time line format that covers a predetermined period of time, such as a day. Of the events in event schedule 412, only event 412a is shown with additional detail. In particular, presentation component 398 may have selected event 412a, at least based on impact scores associated with events 412a, 412b, and 412c, and optionally based on other factors, such as unusualness scores. Event 412a is shown in association with icon 416, which presentation component 398 may selectively display based on event 412a being categorized as impactful and/or unusual. Furthermore, content 400 can optionally comprise change indicator 415, which indicates one or more event attributes that changed for the event. In some cases, change indicator 415 may be based on the highest contributing factor of a change to an event or otherwise be based on the impact score.

By way of example, pane 410 displays event attributes of event 412a including the start time, end time, and location. Expanded pane 418 in FIG. 4B comprises additional content associated with the event, including additional event attributes. For example, information from contact entries associated with attendees of the event are shown. Further various selectable actions are presented to the user in association with event 412a. The examples shown include a respond action, a running late action, and a call action. At least one of those actions may be presented based on the categorization of the impact score and/or unusualness score for the event and/or a categorization of the urgency score. Interacting with an action may trigger one or more associated interfaces to assist the user with respect to the event. Thus, the user can be assisted in various ways so as to better cope with the impactful event.

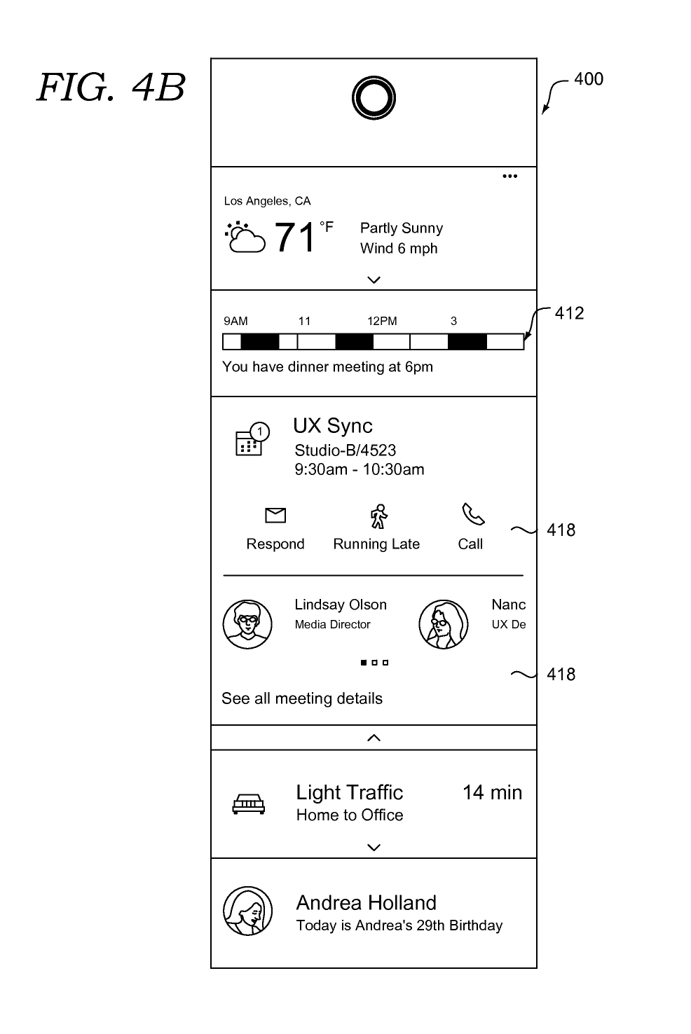

Referring now to FIG. 5, FIG. 5 depicts a flow diagram of method 500 for analyzing events of users, in accordance with an implementation of the invention. At block 510, method 500 includes receiving a notification of a change to an event associated with a user. For example, event analyzer 366 may receive a notification message that one or more event attributes 378 of event 382a has changed. Changes may be captured by event difference data 375 which can indicate or include updated values for one or more even attributes and could be included in the notification message. In some cases, the notification message is from a user device, such as user device 102a. A change to event attributes 378 can correspond to addition, removal, and/or modification of an event attribute (e.g., a value thereof).

At block 520, method 500 includes generating an impact score for the change based on the event attributes of the event with respect to routine-related aspects associated with the user. For example, event analyzer 366 can generate, or determine, the impact score by determining a difference in a level of deviation caused by the change, between the one or more event attributes and the routine-related aspects (e.g., routine-related aspects 368) and based on comparing a time of the event to a reference time. The difference can correspond to an unusualness difference score and the comparing may result in an urgency score that can be combined with the unusualness difference score to result in the impact score.

At block 530, method 500 includes generating service content for the user based on the impact score. For example, presentation component 398 may generate at least a portion of content 399 (which can correspond to content 400 in FIGS. 4A and 4B) based at least in part on the impact score generated for the change to event 382a. The service content can be generated based on a relative value of the impact score as compared to one or more other impact scores.

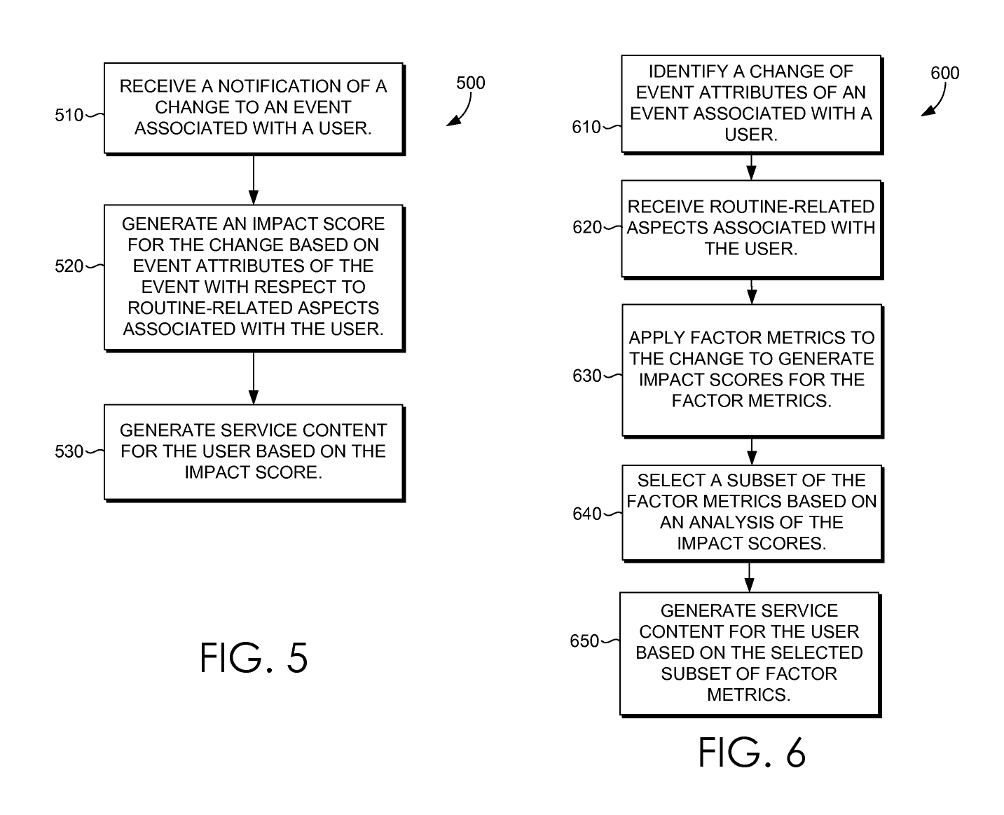

Referring now to FIG. 6, FIG. 6 depicts a flow diagram of method 600 for analyzing events of users, in accordance with an implementation of the invention. At block 610, method 600 includes identifying a change of event attributes of an event stored in association with a user. For example, event analyzer 366 may identify the change of event attributes 378 of event 382a based on event difference data 375. The identification may be performed in response to a notification of the change, which may be from user device 102a or another device. The change may been detected by the user device or another device, causing the notification to be provided to event analyzer 366.

At block 620, method 600 includes receiving routine-related aspects associated with a user. For example, event analyzer 366 may receive routine-related aspects 368 generated from one or more user routine models associated with the user. The one or more user routine models may be trained based at least in part on interaction data comprised of sensor data reflecting user activity detected by one or more sensors.

At block 630, method 600 includes applying factor metrics to the changes to generate impact scores for the factor metrics. For example, event analyzer 366 can apply any combination or subset of the factors described above, and/or other factors to the changes in the event attributes of event 382a of events 382. Each factor metric may have a respective impact score and each impact score can be based on a difference in a level of deviation caused by the change, between a set of the event attributes of the event and a set of routine-related aspects and based on comparing a time of the event to a reference time. The same reference time may be used for each impact score.

At block 640, method 600 includes selecting a subset of the factor metrics based on an analysis of the impact scores. For example, event analyzer 366 may select a subset of the factor metrics based on an analysis of the impact score of each of the factor metrics. In should be noted there as used herein, “a set” can include one or more members or elements. Similarly, “a subset” can include one or more members or elements. However, it is noted that a subset of a set implies that the set includes at least two members.

At block 650, method 600 includes generating service content for the user based on the selected subset of factor metrics. For example, event analyzer 366 may generate content 399 (which can correspond to content 400 in FIGS. 4A and 4B) for the user based at least in part on the selected subset of the factor metrics.

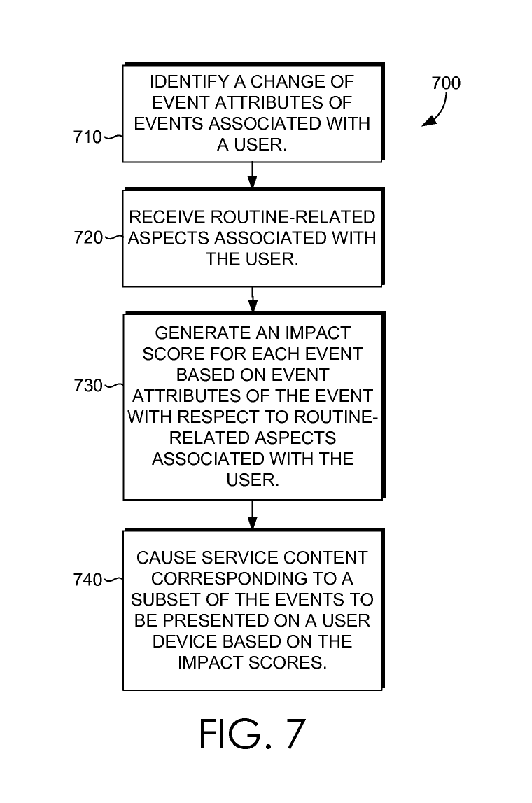

Referring now to FIG. 7, FIG. 7 depicts a flow diagram of method 700 for analyzing events of users, in accordance with an implementation of the invention. At block 710, method 700 includes identifying a change of event attributes of event associated with a user. For example, event analyzer 366 may identify, for each of events 382 (or a subset thereof where only some of the events changed), stored in association with a user, a change of the event attributes of the event based on event difference data 375 for each event. The identification may be performed in response to one or more notifications of the change, which may be from user device 102a or another device. In particular, one notification could be used for each event that has a change, or one notification could correspond to multiple events. In some cases, notifications are received from different user devices, such as a mobile phone and a personal computer. This might occur where the user changed a first event on a first user device and a second event on a second user device.

At block 720, method 700 includes receiving routine-related aspects associated with the user. For example, event analyzer 366 may receive routine-related aspects generated from one or more user routine models associated with the user. The one or more user routine models may be trained based at least in part on interaction data comprised of sensor data reflecting user activity detected by one or more sensors.

At block 730, method 700 includes generating an impact score for each event based on event attributes of the event with respect to routine-related aspects association with the user. For example, event analyzer 366 may generate, generating at least one impact score for each event of events 382 by analyzing the change of the event attributes of the event with respect to the routine-related aspects, wherein the impact score is generated by determining a difference in a level of deviation caused by the change, between the event attributes and the routine-related aspects and based on comparing a time of the event to a reference time. It is noted that multiple impact scores may be generated for any event. Further, an impact score could be an overall impact score, a composite impact score, or a factor impact score (an impact score for a specific factor).

At block 740, method 700 includes causing content corresponding to a subset of the events to be presented on a user device of the user based on the impact scores. For example, event analyzer 366 may cause content 399 (which may correspond to content 400 or portions thereof) corresponding to a subset of events 382 to be presented on user device 102a of the user based on the impact scores of at least some of the subset of events 382. As an example, the subset of the events may be displayed in the content without displaying the other events, or the subset of events may be otherwise distinguished from the other events using icons, labels, and/or other indicia.

Thus, various aspects of technology has been described that is directed, in part, to systems and methods for inferring unusualness of events for a user based, in part, on sensor data reflecting user activity detected by one or more sensors. It is understood that various features, sub-combinations, and modifications of the implementations described herein are of utility and may be employed in other implementations without reference to other features or sub-combinations. Moreover, the order and sequences of steps shown in the example methods are not meant to limit the scope of the present invention in any way, and in fact, the steps may occur in a variety of different sequences within implementations hereof. Such variations and combinations thereof are also contemplated to be within the scope of implementations of the invention.

Having described various implementations of the invention, an exemplary computing environment suitable for implementing implementations of the invention is now described. With reference to FIG. 8, an exemplary computing device is provided and referred to generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

Implementations of the invention may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Implementations of the invention may be practiced in a variety of system configurations, including handheld devices, consumer electronics, general-purpose computers, more specialty computing devices, etc. Implementations of the invention may also be practiced in distributed computing environments where tasks are performed by remote-processing devices that are linked through a communications network. In a distributed computing environment, program modules may be located in both local and remote computer storage media including memory storage devices.

With reference to FIG. 8, computing device 800 includes bus 810 that directly or indirectly couples the following devices: memory 812, one or more processors 814, one or more presentation components 816, one or more input/output (I/O) ports 818, one or more I/O components 820, and illustrative power supply 822. Bus 810 represents what may be one or more busses (such as an address bus, data bus, or combination thereof). Although the various blocks of FIG. 8 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 8 is merely illustrative of an exemplary computing device that can be used in connection with one or more implementations of the present invention. Distinction is not made between such categories as “workstation,” “server,” “laptop,” “handheld device,” etc., as all are contemplated within the scope of FIG. 8 and with reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors 814 that read data from various entities such as memory 812 or I/O components 820. Presentation component(s) 816 presents data indications to a user or other device. Exemplary presentation components include a display device, speaker, printing component, vibrating component, and the like.

I/O ports 818 allow computing device 800 to be logically coupled to other devices, including I/O components 820, some of which may be built in. Illustrative components include a microphone, joystick, game pad, satellite dish, scanner, printer, wireless device, etc. I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 800. Computing device 800 may be equipped with depth cameras, such as stereoscopic camera systems, infrared camera systems, RGB camera systems, and combinations of these, for gesture detection and recognition. Additionally, computing device 800 may be equipped with accelerometers or gyroscopes that enable detection of motion. The output of the accelerometers or gyroscopes may be provided to the display of computing device 800 to render immersive augmented reality or virtual reality.

Some implementations of computing device 800 may include one or more radio(s) 824 (or similar wireless communication components). Radio 824 transmits and receives radio or wireless communications. Computing device 800 may be a wireless terminal adapted to receive communications and media over various wireless networks. As such, computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Implementations of the present invention have been described with the intent to be illustrative rather than restrictive. Alternative implementations will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computerized system comprising:
one or more sensors configured to provide sensor data reflecting user activity detected by the one or more sensors;
an event analyzer configured generate an impact score for a change to one or more event attributes of a plurality of event attributes of an event associated with a user based on routine-related aspects generated from one or more user routine models associated with the user, the one or more user routine models trained based at least in part on interaction data comprised of the sensor data;
one or more processors; and
one or more computer storage media storing computer-useable instructions that, when used by the one or more processors, cause the one or more processors to perform operations comprising:
receiving, using the event analyzer, a notification of the change to the one or more event attributes;
generating the impact score based on the received notification by determining a difference in a level of deviation caused by the change, between the one or more event attributes and the routine-related aspects and based on comparing a time of the event to a reference time; and
generating service content for the user based at least in part on the impact score generated for the change.

2. The computerized system of claim 1, wherein at least one of the routine-related aspects is a commute-related aspect generated from at least one commute-related routine model trained based on detecting a commute pattern of the user in the sensor data.

3. The computerized system of claim 1, wherein at least one of the routine-related aspects is a sleep-related aspect generated from at least one sleep-related routine model trained based on detecting a sleep pattern of the user in the sensor data.

4. The computerized system of claim 1, wherein at least one of the routine-related aspects is a location-related aspect generated from at least one location visitation-related routine model trained based on detecting a location visitation patterns of the user in the sensor data.

5. The computerized system of claim 1, wherein at least one of the routine-related aspects is an affinity-related aspect generated from at least one affinity-related routine model trained based on detecting affinity patterns of the user in the sensor data with respect to one or more contacts of the user.

6. The computerized system of claim 1, wherein the sensor data includes user activity occurring over more than one user device.

7. The computerized system of claim 1, wherein the one or more event attributes comprise a location of the event and a scheduled time of the event and the impact score is based, at least in part, on a probability that the user is at or near the location of the event at or near the time of the event, the probability being calculated based on at least one of the one or more user routine models that is trained based on spatial-temporal data points extracted from the sensor data.

8. The computerized system of claim 1, wherein the determining the difference in the level of deviation caused by the change, between the one or more event attributes and the routine-related aspects comprises:
determining a first level of deviation between the one or more event attributes and the routine-related aspects prior to the change;
determining a second level of deviation between the one or more event attributes and the routine-related aspects with the change; and
calculating the difference in the level of deviation using the first level of deviation and the second level of deviation.

9. The computerized system of claim 1, wherein the generating of the service content for the user based at least in part on the impact score generated for the change comprises automatically notifying the user of the change on a user device associated with the user.

10. The computerized system of claim 1, wherein the generating of the service content for the user comprises selecting from a manner of display for the service content from a plurality of predefined manners of display based on the impact score exceeding a threshold value.

11. The computerized system of claim 1, wherein the event corresponds to an event entry in a calendar application.

13. A computerized method comprising:
identifying a changes of event attributes of an event stored in association with a user;
receiving, routine-related aspects generated from one or more user routine models associated with the user, the one or more user routine models trained based at least in part on interaction data comprised of sensor data reflecting user activity detected by one or more sensors;
applying factor metrics to the change of the event attributes to generate impact scores, each impact score corresponding to a respective factor metric and being based on a difference in a level of deviation caused by the change, between a set of the event attributes of the event and a set of routine-related aspects and based on comparing a time of the event to a reference time;
selecting a subset of the factor metrics based on an analysis of the impact score of each of the factor metrics; and
generating service content for the user based at least in part on the selected subset of the factor metrics.

14. The computerized method of claim 13, wherein a factor metric is included in the subset of the factor metrics based on having a highest impact score of the factor metrics.

15. The computerized method of claim 13, further comprising assigning one or more categories to the event based on the impact scores of the factor metrics, wherein at least some of the service content is predetermined based on the one or more categories assigned to the event.

16. The computerized method of claim 13, further comprising combining the factor metrics into an overall impact score for the event that is based on the difference in the level of deviation for each factor metric, wherein the generating service content for the user is based at least in part on the overall impact score.

17. The computerized method of claim 13, wherein at least one of the factor metrics is a location-visitation based factor, the level deviation being based on a distance between a location of the event from a predicted location of the user during the event.

18. One or more computer storage devices storing computer-useable instructions that, when used by one or more computing devices, cause the one or more computing devices to perform a method, the method comprising:
identifying, for each event of events stored in association with a user, a change of event attributes of the event;
receiving, routine-related aspects generated from one or more user routine models associated with the user, the one or more user routine models trained based at least in part on interaction data comprised of sensor data reflecting user activity detected by one or more sensors;
generating an impact score for each event of the events by analyzing the change of the event attributes of the event with respect to the routine-related aspects, the impact score being generated by determining a difference in a level of deviation caused by the change, between the event attributes and the routine-related aspects and based on comparing a time of the event to a reference time;
causing service content corresponding to a subset of the events to be presented on a user device of the user based on the impact score of each event in the subset of events.

19. The one or more computer storage devices of claim 18, wherein a same reference time is used as the reference time for the generating of the impact score for each event.

20. The one or more computer storage devices of claim 18 comprising causing the subset of the events to be presented on a user device of the user as part of a summary report on events scheduled for the user.
